(19) United States
(12) Patent Application Publication
(10) Pub. No.: US 2008/0196945 A1
(43) Pub. Date: Aug. 21, 2008

(54) Preventing unintentional activation of a sensor element of a sensing device

(76) Inventor: Jason Konstas, Tokyo (JP)

Correspondence Address: CYPRESS/BLAKELY, BLAKELY SOKOLOFF TAYLOR & ZAFMAN, 1279 OAKMEAD PARKWAY, SUNNYVALE, CA, 94085-4040, US

(21) Appl. No.: 11/709,897

(22) Filed: Feb. 21, 2007

(51) Int. Cl. G06F 3/041

(52) U.S. Cl. 178/18.03

(57) ABSTRACT

An apparatus and method for preventing unintentional activations of one or more sensor elements caused by a conductive object using all the sensor elements, using an additional sensor element, or using recessed sensor elements.

### TECHNICAL FIELD

This invention relates to the field of user interface devices and, in particular, to touch-sensor devices.

### BACKGROUND

Computing devices, such as notebook computers, personal data assistants (PDAs), and mobile handsets, have user interface devices, which are also known as human interface devices (HID). One user interface device that has become more common is a touch-sensor pad (also commonly referred to as a touchpad). A basic notebook computer touch-sensor pad emulates the function of a personal computer (PC) mouse. A touch-sensor pad is typically embedded into a PC notebook for built-in portability. A touch-sensor pad replicates mouse x/y movement by using two defined axes which contain a collection of sensor elements that detect the position of a conductive object, such as a finger. Mouse right/left button clicks can be replicated by two mechanical buttons, located in the vicinity of the touchpad, or by tapping commands on the touch-sensor pad itself. The touch-sensor pad provides a user interface device for performing such functions as positioning a cursor, or selecting an item on a display. These touch-sensor pads may include multi-dimensional sensor arrays for detecting movement in multiple axes. The sensor array may include a one-dimensional sensor array, detecting movement in one axis. The sensor array may also be two dimensional, detecting movements in two axes.

One type of touchpad operates by way of capacitance sensing utilizing capacitive sensors. The capacitance detected by a capacitive sensor changes as a function of the proximity of a conductive object to the sensor. The conductive object can be, for example, a stylus or a user's finger. In a touch-sensor device, a change in capacitance detected by each sensor in the X and Y dimensions of the sensor array due to the proximity or movement of a conductive object can be measured by a variety of methods. Regardless of the method, usually an electrical signal representative of the capacitance detected by each capacitive sensor is processed by a processing device, which in turn produces electrical or optical signals representative of the position of the conductive object in relation to the touch-sensor pad in the X and Y dimensions. A touch-sensor strip, slider, or button operates on the same capacitance-sensing principle.

Another user interface device that has become more common is a touch screen. Touch screens, also known as touchscreens, touch panels, or touchscreen panels are display overlays which are typically either pressure-sensitive (resistive), electrically-sensitive (capacitive), acoustically-sensitive (SAW—surface acoustic wave) or photo-sensitive (infra-red). The effect of such overlays allows a display to be used as an input device, removing the keyboard and/or the mouse as the primary input device for interacting with the display's content. Such displays can be attached to computers or, as terminals, to networks. There are a number of types of touch screen technology, such as optical imaging, resistive, surface wave, capacitive, infrared, dispersive signal, and strain gauge technologies. Touch screens have become familiar in retail settings, on point of sale systems, on ATMs, on mobile handsets, on game consoles, and on PDAs where a stylus is sometimes used to manipulate the graphical user interface (GUI) and to enter data.

FIG. 1A illustrates a conventional touch-sensor pad. The touch-sensor pad 100 includes a sensing surface 101 on which a conductive object may be used to position a cursor in the x- and y-axes, using either relative or absolute positioning, or to select an item on a display. Touch-sensor pad 100 may also include two buttons, left and right buttons 102 and 103, respectively, shown here as an example. These buttons are typically mechanical buttons, and operate much like a left and right button on a mouse. These buttons permit a user to select items on a display or send other commands to the computing device.

FIG. 1B illustrates a conventional linear touch-sensor slider. The linear touch-sensor slider 110 includes a surface area 111 on which a conductive object may be used to position a cursor in the x-axis (or alternatively in any other axis, such as the y-axis). The construct of touch-sensor slider 110 may be the same as that of touch-sensor pad 100. Touch-sensor slider 110 may include a sensor array capable of detection in only one dimension (referred to herein as one-dimensional sensor array). The slider structure may include one or more sensor elements that may be conductive traces. By positioning or manipulating a conductive object in contact or in proximity to a particular portion of the slider structure, the capacitance between each conductive line and ground varies and can be detected. The capacitance variation may be sent as a signal on the conductive line to a processing device. It should also be noted that the sensing may be performed in a differential fashion, obviating the need for a ground reference. For example, by detecting the relative capacitance of each sensor element, the position and/or motion (if any) of the external conductive object can be pinpointed. In one embodiment, it can be determined which sensor element has detected the presence of the conductive object, and it can also be determined the motion and/or the position of the conductive object over multiple sensor elements.

One difference between touch-sensor sliders and touch-sensor pads may be how the signals are processed after detecting the conductive objects. Another difference is that the touch-sensor slider is not necessarily used to convey absolute positional information of a conducting object (e.g., to emulate a mouse in controlling cursor positioning on a display), but rather relative positional information. However, the touch-sensor slider and touch-sensor pad may be configured to support either relative or absolute coordinates, and/or to support one or more touch-sensor button functions of the sensing device.

FIG. 1C illustrates a conventional sensing device having three touch-sensor buttons. Conventional sensing device 120 includes button 121, button 122, and button 123. These buttons may be capacitive touch-sensor buttons. These three buttons may be used for user input using a conductive object, such as a finger.

In general, capacitance touch-sensors are intended to replace mechanical buttons, knobs, and other similar mechanical user interface controls. However, one disadvantage of capacitance touch-sensors over mechanical buttons is that zero force may be required to activate the sensors, resulting in a higher possibility of unintentional activations of the sensors. Using capacitive touch sensors, it is easy to activate multiple buttons at the same time, and activate buttons with objects other than the activating finger, such as a CD, DVD, keys, metal ruler, thumb drive, or the like.

In most cases, it is possible for the user to unintentionally activate the capacitive touch sensors by bringing an object, such as any part of the body or some other object with an infringing capacitance, in close proximity to the sensor. For example, large objects (e.g., disc (DVD or CD), metal ruler, lighter, keys, or the like) brought in close proximity to a touch-sensor panel can activate one or more sensors unintentionally due to its inherent capacitance and physical bulk, as illustrated in FIG. 1D. Similarly, smaller objects (e.g., finger, thumb, thumb-drive, dongle, lighter, or the like) brought near one of the sensors can result in unintentional activation, such as by the object brushing over the sensor, or by the inherent capacitance of the object itself due to its physical bulk, as illustrated in FIG. 1E.

Conventionally, firmware (also referred to as intelligent firmware) has been employed to prevent the simultaneous activation of multiple capacitive touch sensors at the same time. This may be one of the simplest ways to detect unintended activation. For example, one conventional design that uses this type of firmware includes capacitive touch-sensor buttons in a dial pad of a phone. In this design, when the user holds the phone next to his/her face, the capacitive touch-sensor buttons would be activated if there was no intelligent firmware running on the phone, resulting in erroneous operation. The firmware is used to detect that condition and reject all sensor inputs, preventing unintentional activation of the buttons by the face of the user. In many cases, however, multiple button presses need to be allowed, for example, CTRL+ALT+DEL, or SHIFT+ any key, or the like. Firmware methods rejecting multiple button presses can not be employed in those instances.

### BRIEF DESCRIPTION OF THE DRAWINGS

The present invention is illustrated by way of example, and not by way of limitation, in the figures of the accompanying drawings.

FIG. 1A illustrates a conventional touch-sensor pad.

FIG. 1B illustrates a conventional linear touch-sensor slider.

FIG. 1C illustrates a conventional sensing device having three touch-sensor buttons.

FIG. 1D illustrates a conventional sensing device having two touch-sensor buttons that are unintentionally activated by a disc.

FIG. 1E illustrates a conventional sensing device having two touch-sensor buttons that are unintentionally activated by a disc.

FIG. 2 illustrates a block diagram of one embodiment of an electronic system having a processing device for detecting a presence of a conductive object.

FIG. 3A illustrates a varying capacitance sensor element.

FIG. 3B illustrates one embodiment of a sensing device coupled to a processing device.

FIG. 3C illustrates one embodiment of a relaxation oscillator for measuring capacitance on a sensor element.

FIG. 3D illustrates a schematic of one embodiment of a circuit including a sigma-delta modulator and a digital filter for measuring capacitance on a sensor element.

FIG. 4 illustrates a block diagram of one embodiment of an electronic device including a processing device that includes capacitance sensor for measuring the capacitance on a senor array.

FIG. 5A illustrates a graph of a sensitivity of a single touch-sensor button.

FIG. 5B illustrates a graph of capacitance measured on a single touch-sensor button.

FIG. 6A illustrates a top-side view of one embodiment of a sensing device having two touch-sensor buttons and a guard sensor to prevent an unintentional activation of the touch-sensor buttons by a disc.

FIG. 6B a top-side view of illustrates one embodiment of a sensing device having two touch-sensor buttons and a guard sensor to prevent an unintentional activation of the touch-sensor buttons by a thumb drive.

FIG. 7 illustrates one embodiment of two touch-sensor buttons of a sensing device, each having recessed sensor elements to prevent an unintentional activation of the touch-sensor buttons.

FIG. 8A illustrates a bottom-side view of one embodiment of a guard sensor disposed to substantially surround two touch-sensor buttons of a sensing device.

FIG. 8B illustrates a bottom-side view of one embodiment of a guard sensor disposed between two touch-sensor buttons of a sensing device.

FIG. 9 illustrates a top-side view and a bottom-side view of one embodiment of a case of a mobile handset having two touch-sensor buttons and a guard sensor to prevent an unintentional activation of the touch-sensor buttons.

FIG. 10 illustrates one embodiment of a selection circuit coupled to an analog bus for measuring capacitance on the sensor elements and the guard sensor.

FIG. 11 illustrates two embodiments of a method of preventing unintentional activations of the touch-sensor buttons.

FIG. 12 illustrates one embodiment of a method of preventing unintentional activations of the first and second touch-sensor buttons using a guard sensor.

FIG. 13 illustrates a radial slider having multiple sensor elements coupled to a processing device via sensor traces, and a guard sensor disposed outside an arc of the radial slider to prevent unintentional activations of the multiple sensor elements by a conductive object outside of the arc.

FIG. 14 illustrates a radial slider having two sensor traces coupled to a processing device, and a guard sensor disposed outside an arc of the radial slider to prevent unintentional activations of the two sensor traces by a conductive object outside of the arc.

FIG. 15 illustrates a circular slider having multiple sensor elements coupled to a processing device via sensor traces, and a guard sensor disposed outside a ring of the circular slider to prevent unintentional activations of the multiple sensor elements by a conductive object outside of the ring.

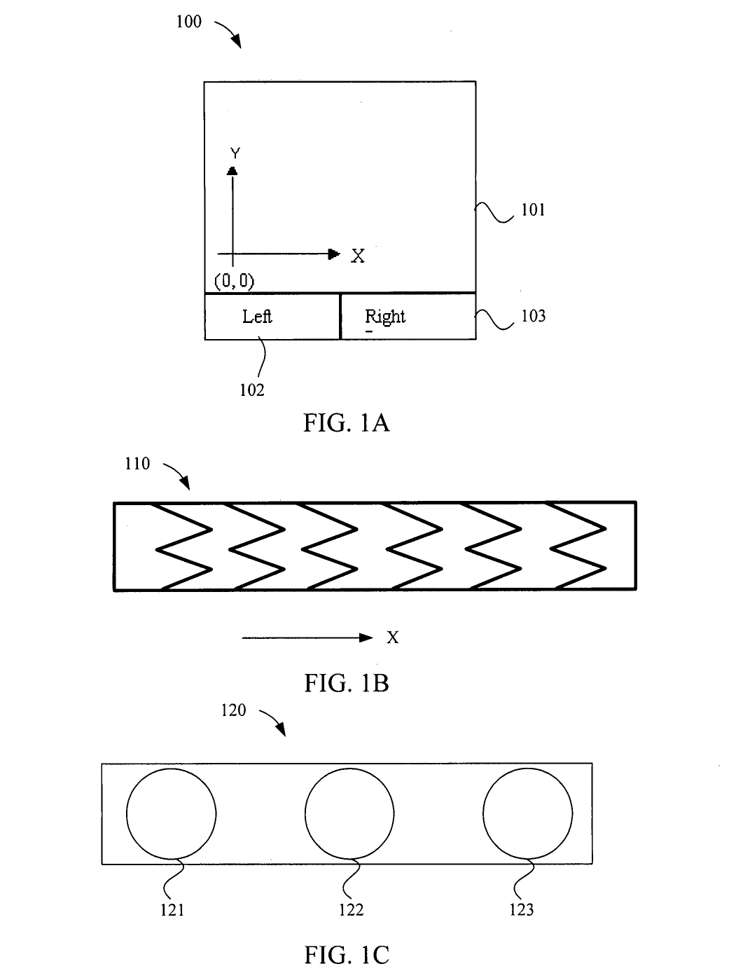

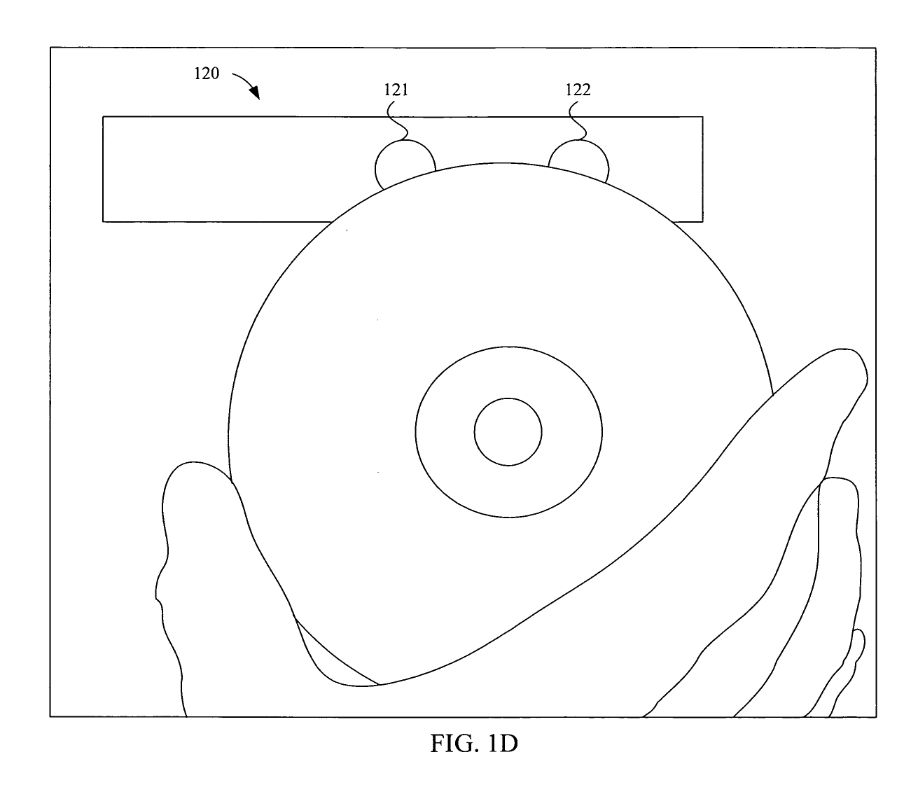

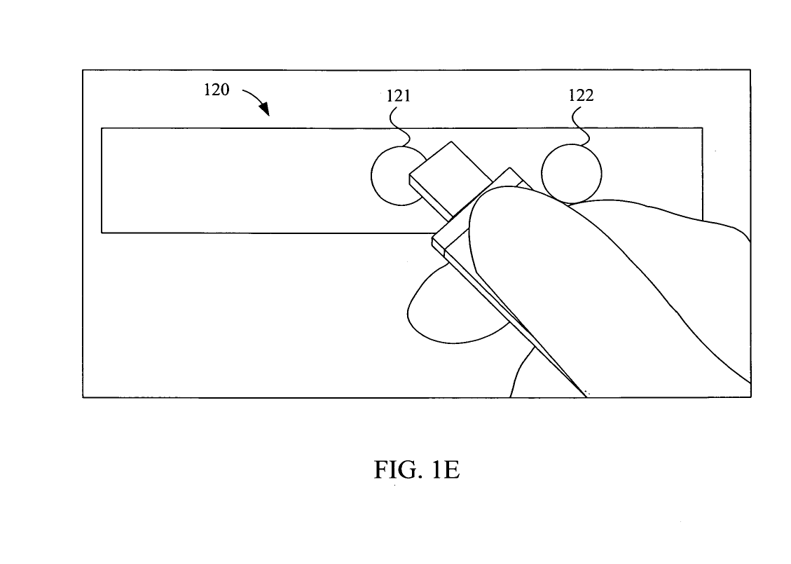

### DETAILED DESCRIPTION

Described herein is an apparatus and method for preventing unintentional activation of one or more sensor elements of a sensing device caused by the conductive object using either an additional sensor element or recessed sensor elements. The following description sets forth numerous specific details such as examples of specific systems, components, methods, and so forth, in order to provide a good understanding of several embodiments of the present invention. It will be apparent to one skilled in the art, however, that at least some embodiments of the present invention may be practiced without these specific details. In other instances, well-known components or methods are not described in detail or are presented in simple block diagram format in order to avoid unnecessarily obscuring the present invention. Thus, the specific details set forth are merely exemplary. Particular implementations may vary from these exemplary details and still be contemplated to be within the spirit and scope of the present invention.

In one embodiment, the method includes coupling each of the sensor elements to the additional sensor element, and measuring a capacitance on all the coupled sensor elements. The method further includes determining whether the capacitance is greater than a rejection threshold, and preventing or ignoring the unintentional activation when the capacitance is greater than the rejection threshold. In another embodiment, the method includes measuring a capacitance on the additional sensor element, and preventing or ignoring the unintentional activation when the capacitance is greater than the rejection threshold.

In one embodiment, the apparatus includes a first sensor element (e.g., guard sensor), one or more additional sensor elements of a sensing device (e.g., touch panel having a touch-sensor button, a circular or a radial slider, a touchpad, or the like) and a processing device that is configured to prevent the unintentional activations of the one or more sensor elements by a conductive object. The processing device uses the first sensor element (e.g., guard sensor) to prevent the unintentional activation of the one or more sensor elements of the sensing device. The processing device may measure the capacitance on the first sensor element to detect the presence of the conductive object. The processing device may also be configured to be coupled to the first capacitance sensor and the one or more additional sensor elements, and measure the capacitance on the coupled sensor elements. In one embodiment, the conductive object is larger than a finger, such as a disc (DVD or CD), metal ruler, a hand, keys, or the like. The conductive object brought in close proximity to the touch-sensor panel may activate one or more sensors unintentionally due to its inherent capacitance and physical bulk. However, the first sensor element can be used to prevent the unintentional activation by the conductive object. In another embodiment, the conductive object is smaller than the conductive objects described above, such as a finger, thumb, thumb-drive, dongle, connector, lighter, or the like. These smaller objects brought near one of the sensors may result in unintentional activation, such as by the object brushing over the sensor, or by the inherent capacitance of the object itself due to its physical bulk. Similarly, the first sensor element can be used to prevent the unintentional activation by the conductive object.

The embodiments described herein may proactively prevent the unintended activation of capacitive touch sensors by such objects with infringing capacitance through the use of an additional capacitive touch sensor element, also referred herein as the “guard” sensor. The use of an additional input from an additional capacitive sensor element, as a proximity detecting “guard” sensor may prevent the unintentional activation of other sensor elements that correspond to touch-sensor inputs, such a touch-sensor button. The physical location and shape of the guard sensor may be application dependent, but its purpose is to protect the main capacitive touch sensors from unintentional activation by detecting the presence of objects in close proximity to them.

In one embodiment, a user can activate a touch-sensor button by directly pressing or placing their finger (or other conductive object) on top of the conductive sensor element (e.g., on the overlay which insulates the sensor element). However, if the user activates the guard sensor in addition to the sensor element, activations of the sensor element are ignored. These activations of the sensor element are considered unintentional activations since they also activated the guard sensor. The guard sensor may be configured to successfully reject large objects, such as DVDs, metal rulers or other large objects that might accidentally be placed on the sensor panel that would otherwise unintentionally activate the sensor element.

The guard sensor shape and location is designed to detect objects that are close to the main touch-sensor buttons, or objects that cover the entire touch panel at once. The guard sensor may also be configured to allow the user to simultaneously activate two or more touch-sensor buttons at the same time, as long as the guard sensor is not activated. In one embodiment, the guard sensor surrounds the other sensor elements with an insulation area (e.g., non-conductive material) in between the guard sensor and the other sensor elements. The insulation area may be optimized to allow for presses that are not strictly 90 degree oblique to the sensor panel, yet still reject accidental presses from foreign objects. Foreign objects may be conductive objects that are not intended to activate the touch-sensor buttons, but unintentionally activate the touch-sensor buttons when in proximity to the touch-sensor buttons. Alternatively, the guard sensor may be disposed in other locations with respect to the other sensor elements.

Some of the embodiments described herein may allow a panel designer to maintain a flat touch panel free of mechanical mechanisms for preventing unintentional activations of the touch-sensor buttons, such as button recesses, guard rails, or the like, and the touch panel may be configured to allow multiple sensors to be activated simultaneously if the user interface requires it. The designer can customize the shape of the guard sensor as required to reject objects around the touch-sensors. The shape, size, and location of the guard sensor may be chosen by the panel designer to protect the touch-sensor from unintentional activation of the touch-sensors of the touch panel. In addition, the gain or sensitivity of the guard sensor may be optimized in the processing device to ensure that foreign objects are rejected while intended button presses are accepted.

The embodiments described herein may include no extra components used in conventional touch panels to prevent the unintentional activations of the touch-sensor buttons, except some additional conductive material for the guard sensor and one additional capacitance sensing pin to be coupled to the additional conductive material. The guard sensor may be an additional conductive area placed on the same surface that is already coated with conductive material for the touch-sensor buttons (e.g., sensor elements).

The processing device may be configured to measure the capacitance variation on the guard sensor, and if the capacitance variation exceeds a rejection threshold, then the processing device is configured to reject or ignore the button presses of the touch-sensor buttons of the touch panel. In one embodiment, the rejection threshold is programmable. Alternatively, the rejection threshold may be fixed. In one embodiment, the rejection threshold is a noise threshold. In another embodiment, the rejection threshold is a presence threshold. Alternatively, other thresholds may be used.

In one embodiment, the guard sensor can be configured as a short range (e.g., 1-5 mm typically) proximity sensor by increasing the gain applied to the capacitance measurement of the guard sensor. In this embodiment, the intention is to proactively detect and reject infringing foreign objects from unintentionally activating the touch sensor inputs before the object touches the sensor panel.

Mechanical guard methods, such as recessed buttons or guard rails, can also be employed to prevent accidental activation. Mechanical guard methods have been used in resistive applications, but may not have been used in capacitance sensing applications. However, these mechanical guard methods may include some drawbacks, such as detracting from the industrial design (e.g. the styling, look and feel etc.) of the end product which is one of the main reasons for the adoption of capacitive touch sensors, and space constraints of the device. Some devices (e.g., cellular phone, digital camera) may limit the use of mechanical guard methods due to the space constraints of the device.

As described above, capacitance touch-sensors may require zero force to activate the sensor, which may result in a higher possibility of unintentional activations of the sensors. The embodiments described herein; however, reduce the possibility of unintentional activations of the sensor elements using either a guard sensor, or recessed sensor elements. The embodiments described herein provide a reliable method for preventing unintentional activations with no additional cost or manufacturing steps. Some of the embodiments described herein maintain a completely flat touch panel, free from button recesses, guard rails, and other mechanical mechanisms to prevent the unintentional activations. The embodiments described herein also may allow multiple sensors to be activated simultaneously, unlike the conventional designs.

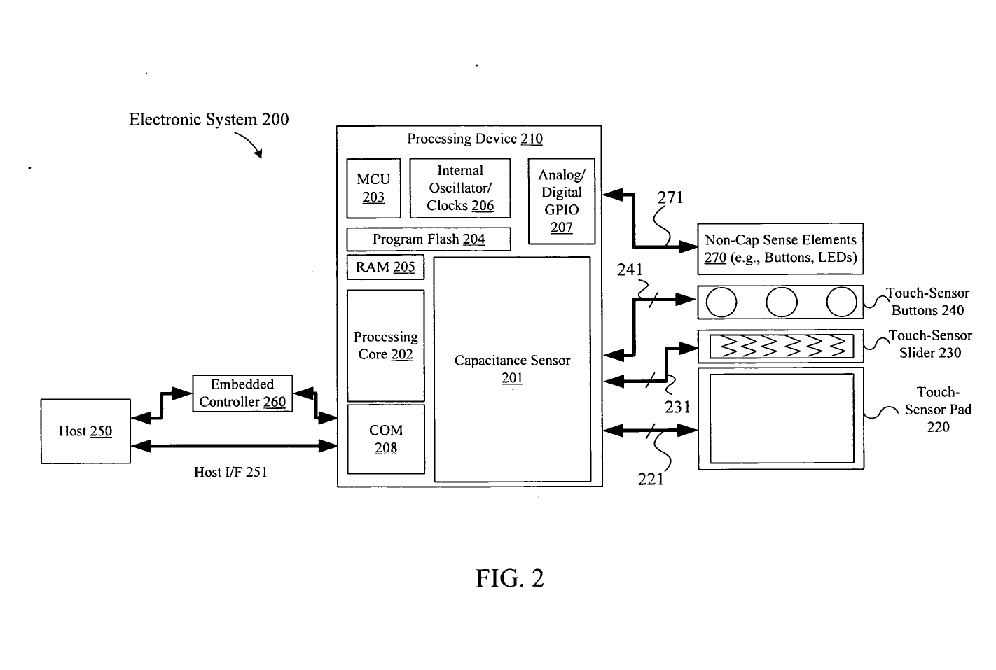

FIG. 2 illustrates a block diagram of one embodiment of an electronic system having a processing device for detecting a presence of a conductive object. Electronic system 200 includes processing device 210, touch-sensor pad 220, touch-sensor slider 230, touch-sensor buttons 240, host processor 250, embedded controller 260, and non-capacitance sensor elements 270. The processing device 210 may include analog and/or digital general purpose input/output (“GPIO”) ports 207. GPIO ports 207 may be programmable. GPIO ports 207 may be coupled to a Programmable Interconnect and Logic (“PIL”), which acts as an interconnect between GPIO ports 207 and a digital block array of the processing device 210 (not illustrated). The digital block array may be configured to implement a variety of digital logic circuits (e.g., DAC, digital filters, digital control systems, etc.) using, in one embodiment, configurable user modules (“UMs”). The digital block array may be coupled to a system bus (not illustrated). Processing device 210 may also include memory, such as random access memory (RAM) 205 and program flash 204. RAM 205 may be static RAM (SRAM) or the like, and program flash 204 may be a non-volatile storage, or the like, which may be used to store firmware (e.g., control algorithms executable by processing core 202 to implement operations described herein). Processing device 210 may also include a memory controller unit (MCU) 203 coupled to memory and the processing core 202.

The processing device 210 may also include an analog block array (not illustrated). The analog block array is also coupled to the system bus. Analog block array also may be configured to implement a variety of analog circuits (e.g., ADC, analog filters, etc.) using, in one embodiment, configurable UMs. The analog block array may also be coupled to the GPIO 207.

As illustrated, capacitance sensor 201 may be integrated into processing device 210. Capacitance sensor 201 may include analog I/O for coupling to an external component, such as touch-sensor pad 220, touch-sensor slider 230, touch-sensor buttons 240, and/or other devices. Capacitance sensor 201 and processing device 202 are described in more detail below.

It should be noted that the embodiments described herein are not limited to touch-sensor pads for notebook implementations, but can be used in other capacitive sensing implementations, for example, the sensing device may be a touch screen, a touch-sensor slider 230, or a touch-sensor button 240 (e.g., capacitance sensing button). It should also be noted that the embodiments described herein may be implemented in other sensing technologies than capacitive sensing, such as resistive, optical imaging, surface wave, infrared, dispersive signal, and strain gauge technologies. Similarly, the operations described herein are not limited to notebook cursor operations, but can include other operations, such as lighting control (dimmer), volume control, graphic equalizer control, speed control, or other control operations requiring gradual or discrete adjustments. It should also be noted that these embodiments of capacitive sensing implementations may be used in conjunction with non-capacitive sensing elements, including but not limited to pick buttons, sliders (ex. display brightness and contrast), scroll-wheels, multi-media control (ex. volume, track advance, etc) handwriting recognition and numeric keypad operation.

In one embodiment, the electronic system 200 includes a touch-sensor pad 220 coupled to the processing device 210 via bus 221. Touch-sensor pad 220 may include a two-dimension sensor array. The two-dimension sensor array includes multiple sensor elements, organized as rows and columns. In another embodiment, the electronic system 200 includes a touch-sensor slider 230 coupled to the processing device 210 via bus 231. Touch-sensor slider 230 may include a single-dimension sensor array. The single-dimension sensor array includes multiple sensor elements, organized as rows, or alternatively, as columns. In another embodiment, the electronic system 200 includes touch-sensor buttons 240 coupled to the processing device 210 via bus 241. Touch-sensor button 240 may include a single-dimension or multi-dimension sensor array. The single- or multi-dimension sensor array includes multiple sensor elements. For a touch-sensor button, the sensor elements may be coupled together to detect a presence of a conductive object over the entire surface of the sensing device. Alternatively, the touch-sensor button 240 has a single sensor element to detect the presence of the conductive object. In one embodiment, the touch-sensor button 240 may include a sensor element. Capacitance sensor elements may be used as non-contact sensor element. These sensor elements, when protected by an insulating layer, offer resistance to severe environments.

The electronic system 200 may include any combination of one or more of the touch-sensor pad 220, touch-sensor slider 230, and/or touch-sensor button 240. In another embodiment, the electronic system 200 may also include non-capacitance sensor elements 270 coupled to the processing device 210 via bus 271. The non-capacitance sensor elements 270 may include buttons, light emitting diodes (LEDs), and other user interface devices, such as a mouse, a keyboard, or other functional keys that do not require capacitance sensing. In one embodiment, buses 271, 241, 231, and 221 may be a single bus. Alternatively, these buses may be configured into any combination of one or more separate buses.

The processing device may also provide value-added functionality such as keyboard control integration, LEDs, battery charger and general purpose I/O, as illustrated as non-capacitance sensor elements 270. Non-capacitance sensor elements 270 are coupled to the GPIO 207.

Processing device 210 may include internal oscillator/clocks 206 and communication block 208. The oscillator/clocks block 206 provides clock signals to one or more of the components of processing device 210. Communication block 208 may be used to communicate with an external component, such as a host processor 250, via host interface (I/F) line 251. Alternatively, processing block 210 may also be coupled to embedded controller 260 to communicate with the external components, such as host 250. Interfacing to the host 250 can be through various methods. In one exemplary embodiment, interfacing with the host 250 may be done using a standard PS/2 interface to connect to an embedded controller 260, which in turn sends data to the host 250 via a low pin count (LPC) interface. In some instances, it may be beneficial for the processing device 210 to do both touch-sensor pad and keyboard control operations, thereby freeing up the embedded controller 260 for other housekeeping functions. In another exemplary embodiment, interfacing may be done using a universal serial bus (USB) interface directly coupled to the host 250 via host interface line 251. Alternatively, the processing device 210 may communicate to external components, such as the host 250 using industry standard interfaces, such as USB, PS/2, inter-integrated circuit (I2C) bus, or system packet interfaces (SPI). The host 250 and/or embedded controller 260 may be coupled to the processing device 210 with a ribbon or flex cable from an assembly, which houses the sensing device and processing device.

In one embodiment, the processing device 210 is configured to communicate with the embedded controller 260 or the host 250 to send and/or receive data. The data may be a command or alternatively a signal. In an exemplary embodiment, the electronic system 200 may operate in both standard-mouse compatible and enhanced modes. The standard-mouse compatible mode utilizes the HID class drivers already built into the Operating System (OS) software of host 250. These drivers enable the processing device 210 and sensing device to operate as a standard cursor control user interface device, such as a two-button PS/2 mouse. The enhanced mode may enable additional features such as scrolling or disabling the sensing device, such as when a mouse is plugged into the notebook. Alternatively, the processing device 210 may be configured to communicate with the embedded controller 260 or the host 250, using non-OS drivers, such as dedicated touch-sensor pad drivers, or other drivers known by those of ordinary skill in the art.

In one embodiment, the processing device 210 may operate to communicate data (e.g., commands or signals) using hardware, software, and/or firmware, and the data may be communicated directly to the processing device of the host 250, such as a host processor, or alternatively, may be communicated to the host 250 via drivers of the host 250, such as OS drivers, or other non-OS drivers. It should also be noted that the host 250 may directly communicate with the processing device 210 via host interface 251.

In one embodiment, the data sent to the host 250 from the processing device 210 includes click, double-click, movement of the cursor, scroll-up, scroll-down, scroll-left, scroll-right, step Back, and step Forward. In another embodiment, the data sent to the host 250 include the position or location of the conductive object on the sensing device. Alternatively, other user interface device commands may be communicated to the host 250 from the processing device 210. These commands may be based on gestures occurring on the sensing device that are recognized by the processing device, such as tap, push, hop, drag, and zigzag gestures. Alternatively, other commands may be recognized. Similarly, signals may be sent that indicate the recognition of these operations.

In particular, a tap gesture, for example, may be when the finger (e.g., conductive object) is on the sensing device for less than a threshold time. If the time the finger is placed on the touchpad is greater than the threshold time it may be considered to be a movement of the cursor, in the x- or y-axes. Scroll-up, scroll-down, scroll-left, and scroll-right, step back, and step-forward may be detected when the absolute position of the conductive object is within a pre-defined area, and movement of the conductive object is detected.

Processing device 210 may reside on a common carrier substrate such as, for example, an integrated circuit (IC) die substrate, a multi-chip module substrate, or the like. Alternatively, the components of processing device 210 may be one or more separate integrated circuits and/or discrete components. In one exemplary embodiment, processing device 210 may be a Programmable System on a Chip (PSoC™) processing device, manufactured by Cypress Semiconductor Corporation, San Jose, Calif. Alternatively, processing device 210 may be one or more other processing devices known by those of ordinary skill in the art, such as a microprocessor or central processing unit, a controller, special-purpose processor, digital signal processor (DSP), an application specific integrated circuit (ASIC), a field programmable gate array (FPGA), or the like. In an alternative embodiment, for example, the processing device may be a network processor having multiple processors including a core unit and multiple microengines. Additionally, the processing device may include any combination of general-purpose processing device(s) and special-purpose processing device(s).

It should also be noted that the embodiments described herein are not limited to having a configuration of a processing device coupled to a host, but may include a system that measures the capacitance on the sensing device and sends the raw data to a host computer where it is analyzed by an application. In effect the processing that is done by processing device 210 may also be done in the host.

In one embodiment, the method and apparatus described herein may be implemented in a fully self-contained touch-sensor pad, which outputs fully processed x/y movement and gesture data signals or data commands to a host. In another embodiment, the method and apparatus may be implemented in be a touch-sensor pad, which outputs x/y movement data and also finger presence data to a host, and where the host processes the received data to detect gestures. In another embodiment, the method and apparatus may be implemented in a touch-sensor pad, which outputs raw capacitance data to a host, where the host processes the capacitance data to compensate for quiescent and stray capacitance, and calculates x/y movement and detects gestures by processing the capacitance data. Alternatively, the method and apparatus may be implemented in a touch-sensor pad, which outputs pre-processed capacitance data to a host, where the touchpad processes the capacitance data to compensate for quiescent and stray capacitance, and the host calculates x/y movement and detects gestures from the pre-processed capacitance data.

In one embodiment, the electronic system that includes the embodiments described herein may be implemented in a conventional laptop touch-sensor pad. Alternatively, it may be implemented in a wired or wireless keyboard integrating a touch-sensor pad, which is itself connected to a host. In such an implementation, the processing described above as being performed by the “host” may be performed in part or in whole by the keyboard controller, which may then pass fully processed, pre-processed or unprocessed data to the system host. In another embodiment, the embodiments may be implemented in a mobile handset (e.g., cellular or mobile phone) or other electronic devices where the touch-sensor pad may operate in one of two or more modes. For example, the touch-sensor pad may operate either as a touch-sensor pad for x/y positioning and gesture recognition, or as a keypad or other arrays of touch-sensor buttons and/or sliders. Alternatively, the touch-sensor pad, although configured to operate in the two modes, may be configured to be used only as a keypad.

Capacitance sensor 201 may be integrated into the processing device 210, or alternatively, in a separate IC. Alternatively, descriptions of capacitance sensor 201 may be generated and compiled for incorporation into other integrated circuits. For example, behavioral level code describing capacitance sensor 201, or portions thereof, may be generated using a hardware descriptive language, such as VHDL or Verilog, and stored to a machine-accessible medium (e.g., Flash ROM, CD-ROM, hard disk, floppy disk, etc.). Furthermore, the behavioral level code can be compiled into register transfer level (“RTL”) code, a netlist, or even a circuit layout and stored to a machine-accessible medium. The behavioral level code, the RTL code, the netlist, and the circuit layout all represent various levels of abstraction to describe capacitance sensor 201.

It should be noted that the components of electronic system 200 may include all the components described above. Alternatively, electronic system 200 may include only some of the components described above, or include additional components not listed herein.

In one embodiment, electronic system 200 may be used in a notebook computer. Alternatively, the electronic device may be used in other applications, such as a mobile handset, a personal data assistant (PDA), a keyboard, a television, a remote control, a monitor, a handheld multi-media device, a handheld video player, a handheld gaming device, or a control panel.

In one embodiment, capacitance sensor 201 may be a capacitive switch relaxation oscillator (CSR). The CSR may be coupled to an array of sensor elements using a current-programmable relaxation oscillator, an analog multiplexer, digital counting functions, and high-level software routines to compensate for environmental and physical sensor element variations. The sensor array may include combinations of independent sensor elements, sliding sensor elements (e.g., touch-sensor slider), and touch-sensor sensor element pads (e.g., touch pad) implemented as a pair of orthogonal sliding sensor elements. The CSR may include physical, electrical, and software components. The physical component may include the physical sensor element itself, typically a pattern constructed on a printed circuit board (PCB) with an insulating cover, a flexible membrane, or a transparent overlay. The electrical component may include an oscillator or other means to convert a charged capacitance into a measured signal. The electrical component may also include a counter or timer to measure the oscillator output. The software component may include detection and compensation software algorithms to convert the count value into a sensor element detection decision (also referred to as switch detection decision). For example, in the case of slider sensor elements or X-Y touch-sensor sensor element pads, a calculation for finding position of the conductive object to greater resolution than the physical pitch of the sensor elements may be used.

It should be noted that there are various known methods for measuring capacitance. Although some embodiments described herein are described using a relaxation oscillator, the present embodiments are not limited to using relaxation oscillators, but may include other methods, such as current versus voltage phase shift measurement, resistor-capacitor charge timing, capacitive bridge divider, charge transfer, sigma-delta modulators, charge-accumulation circuits, or the like.

The current versus voltage phase shift measurement may include driving the capacitance through a fixed-value resistor to yield voltage and current waveforms that are out of phase by a predictable amount. The drive frequency can be adjusted to keep the phase measurement in a readily measured range. The resistor-capacitor charge timing may include charging the capacitor through a fixed resistor and measuring timing on the voltage ramp. Small capacitance values may require very large resistors for reasonable timing. The capacitive bridge divider may include driving the capacitor under test through a fixed reference capacitor. The reference capacitor and the capacitor under test form a voltage divider. The voltage signal is recovered with a synchronous demodulator, which may be done in the processing device 210. The charge transfer may be conceptually similar to an R-C charging circuit. In this method, C_{P} is the capacitance being sensed. C_{SUM} is the summing capacitor, into which charge is transferred on successive cycles. At the start of the measurement cycle, the voltage on C_{SUM} is reset. The voltage on C_{SUM} increases exponentially (and only slightly) with each clock cycle. The time for this voltage to reach a specific threshold is measured with a counter. Additional details regarding these alternative embodiments have not been included so as to not obscure the present embodiments, and because these alternative embodiments for measuring capacitance are known by those of ordinary skill in the art.

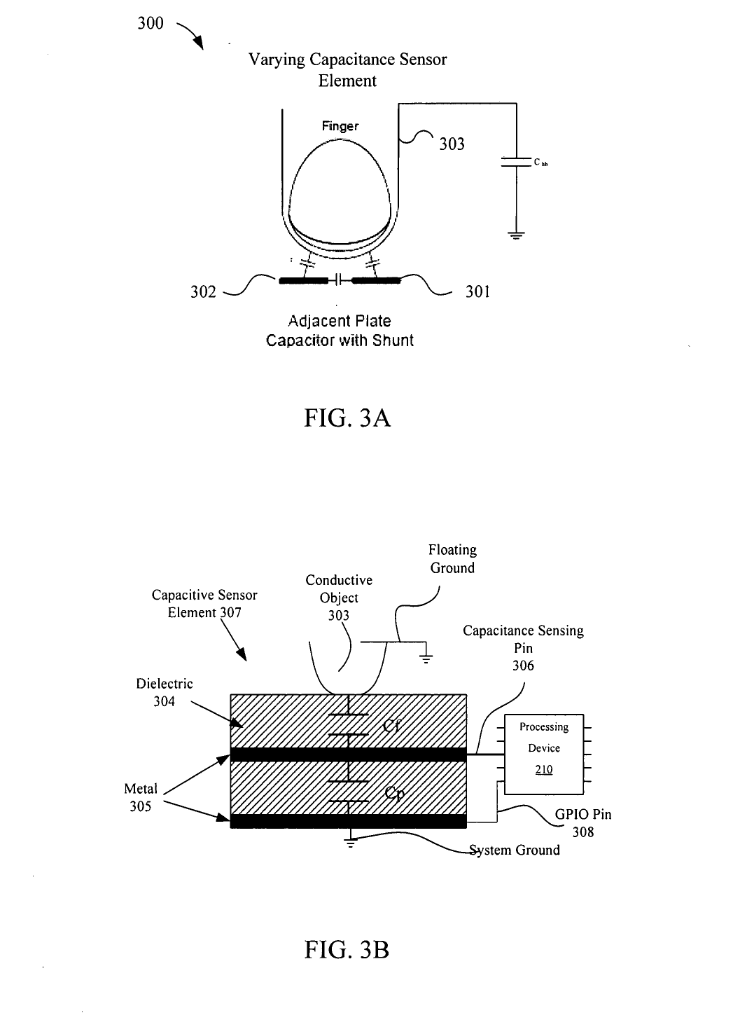

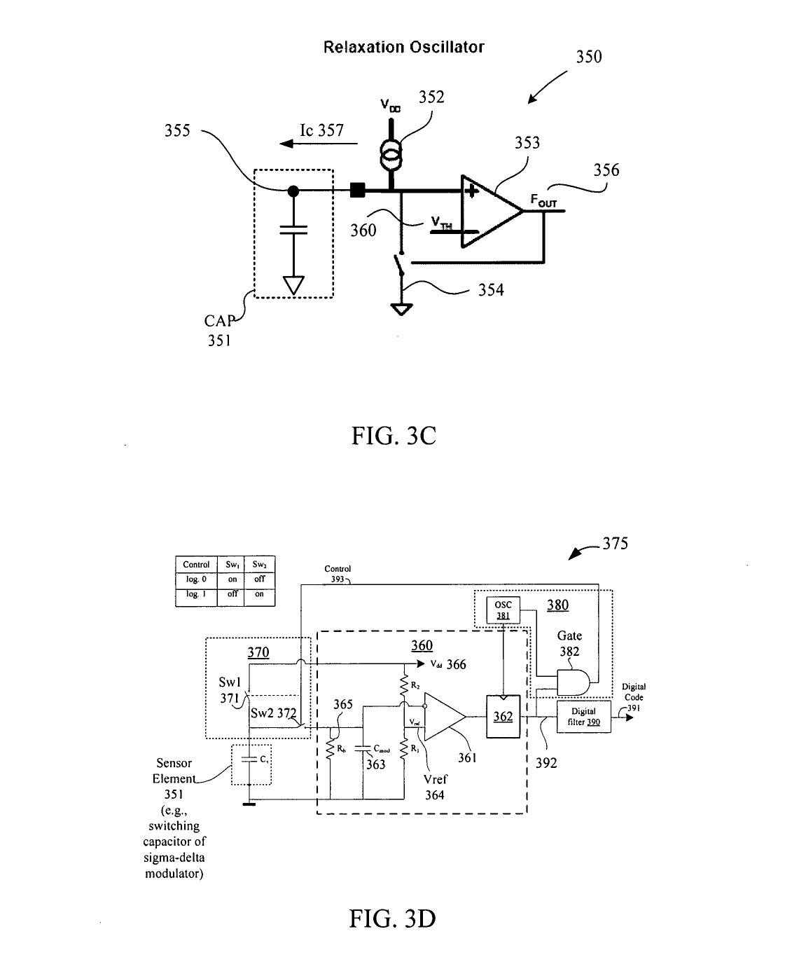

FIG. 3A illustrates a varying capacitance sensor element. In its basic form, a capacitance sensor element 300 is a pair of adjacent conductors 301 and 302. There is a small edge-to-edge capacitance, but the intent of sensor element layout is to minimize the parasitic capacitance Cp between these conductors. When a conductive object 303 (e.g., finger) is placed in proximity to the two conductor 301 and 302, there is a capacitance between electrode 301 and the conductive object 303 and a similar capacitance between the conductive object 303 and the other electrode 302. The capacitance between the electrodes when no conductive object 303 is present is the base capacitance Cp that may be stored as a baseline value. There is also a total capacitance (Cp+Cf) on the sensor element 300 when the conductive object 303 is present on or in close proximity to the sensor element 300. The baseline capacitance value Cp may be subtracted from the total capacitance when the conductive object 303 is present to determine the change in capacitance (e.g., capacitance variation Cf) when the conductive object 303 is present and when the conductive object 303 is not present on the sensor element. Effectively, the capacitance variation Cf can be measured to determine whether a conductive object 303 is present or not (e.g., sensor activation) on the sensor element 300.

Capacitance sensor element 300 may be used in a capacitance sensor array. The capacitance sensor array is a set of capacitors where one side of each capacitor is connected to a system ground. When the capacitance sensor element 300 is used in the sensor array, when the conductor 301 is sensed, the conductor 302 is connected to ground, and when the conductor 302 is sensed, the conductor 301 is connected to ground. Alternatively, when the sensor element is used for a touch-sensor button, the sensor element is sensed and the sensed button area is surrounded by a fixed ground. The presence of the conductive object 303 increases the capacitance (Cp+Cf) of the sensor element 300 to ground. Determining sensor element activation is then a matter of measuring change in the capacitance (Cf) or capacitance variation. Sensor element 300 is also known as a grounded variable capacitor.

The conductive object 303 in this embodiment has been illustrated as a finger. Alternatively, this technique may be applied to any conductive object, for example, a conductive door switch, position sensor, or conductive pen in a stylus tracking system (e.g., stylus).

The capacitance sensor element 300 is known as a projected capacitance sensor. Alternatively, the capacitance sensor element 300 may be a surface capacitance sensor that does not make use of rows or columns, but instead makes use of a single linearized field, such as the surface capacitance sensor described in U.S. Pat. No. 4,293,734. The surface capacitance sensor may be used in touch screen applications.

FIG. 3B illustrates one embodiment of a capacitance sensor element 307 coupled to a processing device 210. Capacitance sensor element 307 illustrates the capacitance as seen by the processing device 210 on the capacitance sensing pin 306. As described above, when a conductive object 303 (e.g., finger) is placed in proximity to one of the conductors 305, there is a capacitance, Cf, between the one of the conductors 305 and the conductive object 303 with respect to ground. This ground, however, may be a floating ground. Also, there is a capacitance, Cp, between the conductors 305, with one of the conductors 305 being connected to a system ground. The grounded conductor may be coupled to the processing device 210 using GPIO pin 308. The conductors 305 may be metal, or alternatively, the conductors may be conductive ink (e.g., carbon ink) or conductive polymers. In one embodiment, the grounded conductor may be an adjacent sensor element. Alternatively, the grounded conductor may be other grounding mechanisms, such as a surrounding ground plane. Accordingly, the processing device 210 can measure the change in capacitance, capacitance variation Cf, as the conductive object is in proximity to one of the conductors 305. Above and below the conductor that is closest to the conductive object 303 is dielectric material 304. The dielectric material 304 above the conductor 305 can be an overlay, as described in more detail below. The overlay may be non-conductive material used to protect the circuitry from environmental conditions and ESD, and to insulate the user's finger (e.g., conductive object) from the circuitry. Capacitance sensor element 307 may be a sensor element of a touch-sensor pad, a touch-sensor slider, or a touch-sensor button.

FIG. 3C illustrates one embodiment of a relaxation oscillator. The relaxation oscillator 350 is formed by the capacitance to be measured on capacitor 351, a charging current source 352, a comparator 353, and a reset switch 354 (also referred to as a discharge switch). It should be noted that capacitor 351 is representative of the capacitance measured on a sensor element of a sensor array. The relaxation oscillator is coupled to drive a charging current (Ic) 357 in a single direction onto a device under test (“DUT”) capacitor, capacitor 351. As the charging current piles charge onto the capacitor 351, the voltage across the capacitor increases with time as a function of Ic 357 and its capacitance C. Equation (1) describes the relation between current, capacitance, voltage and time for a charging capacitor.

CdV=I_{C}dt (1)

The relaxation oscillator begins by charging the capacitor 351, at a fixed current Ic 357, from a ground potential or zero voltage until the voltage across the capacitor 351 at node 355 reaches a reference voltage or threshold voltage, V_{TH} 360. At the threshold voltage V_{TH} 360, the relaxation oscillator allows the accumulated charge at node 355 to discharge (e.g., the capacitor 351 to “relax” back to the ground potential) and then the process repeats itself. In particular, the output of comparator 353 asserts a clock signal F_{OUT} 356 (e.g., F_{OUT} 356 goes high), which enables the reset switch 354. This resets the voltage on the capacitor at node 355 to ground and the charge cycle starts again. The relaxation oscillator outputs a relaxation oscillator clock signal (F_{OUT} 356) having a frequency (f_{RO}) dependent upon capacitance C of the capacitor 351 and charging current Ic 357.

The comparator trip time of the comparator 353 and reset switch 354 add a fixed delay. The output of the comparator 353 is synchronized with a reference system clock to guarantee that the reset time is long enough to completely discharge capacitor 351. This sets a practical upper limit to the operating frequency. For example, if capacitance C of the capacitor 351 changes, then f_{RO} changes proportionally according to Equation (1). By comparing f_{RO} of F_{OUT} 356 against the frequency (f_{REF}) of a known reference system clock signal (REF CLK), the change in capacitance ΔC can be measured. Accordingly, equations (2) and (3) below describe that a change in frequency between F_{OUT} 356 and REF CLK is proportional to a change in capacitance of the capacitor 351.

ΔC∝Δf, where (2)

Δf=f_{RO}−f_{REF}. (3)

In one embodiment, a frequency comparator may be coupled to receive relaxation oscillator clock signal (F_{OUT} 356) and REF CLK, compare their frequencies f_{RO} and f_{REF}, respectively, and output a signal indicative of the difference Δf between these frequencies. By monitoring Δf one can determine whether the capacitance of the capacitor 351 has changed.

In one exemplary embodiment, the relaxation oscillator 350 may be built using a programmable timer (e.g., 555 timer) to implement the comparator 353 and reset switch 354. Alternatively, the relaxation oscillator 350 may be built using other circuiting. Relaxation oscillators are known by those of ordinary skill in the art, and accordingly, additional details regarding their operation have not been included so as to not obscure the present embodiments. The capacitor charging current for the relaxation oscillator 350 may be generated in a register programmable current output DAC (also known as IDAC). Accordingly, the current source 352 may be a current DAC or IDAC. The IDAC output current may be set by an 8-bit value provided by the processing device 210, such as from the processing core 202. The 8-bit value may be stored in a register or in memory.

In many capacitance sensor element designs, the two “conductors” (e.g., 301 and 302) of the sensing capacitor are actually adjacent sensor elements that are electrically isolated (e.g., PCB pads or traces), as indicated in FIG. 3A. Typically, one of these conductors is connected to a system ground. Layouts for touch-sensor slider (e.g., linear slide sensor elements) and touch-sensor pad applications have sensor elements that may be immediately adjacent. In these cases, all of the sensor elements that are not active are connected to a system ground through the GPIO 207 of the processing device 210 dedicated to that pin. The actual capacitance between adjacent conductors is small (Cp), but the capacitance of the active conductor (and its PCB trace back to the processing device 210) to ground, when detecting the presence of the conductive object 303, may be considerably higher (Cp+Cf). The capacitance of two parallel conductors is given by the following equation:

$$C = {ɛ}_{0} \cdot {ɛ}_{R} \cdot \frac{A}{d} = {ɛ}_{R} \cdot 8.85 \cdot \frac{A}{d} pF \text{/} m \qquad ( 4 )$$

The dimensions of equation (4) are in meters. This is a very simple model of the capacitance. The reality is that there are fringing effects that substantially increase the sensor element-to-ground (and PCB trace-to-ground) capacitance.

Sensor element sensitivity (i.e., activation distance) may be increased by one or more of the following: 1) increasing board thickness to increase the distance between the active sensor element and any parasitics; 2) minimizing PCB trace routing underneath sensor elements; 3) utilizing a gridded ground with 50% or less fill if use of a ground plane is absolutely necessary; 4) increasing the spacing between sensor element pads and any adjacent ground plane; 5) increasing pad area; 6) decreasing thickness of any insulating overlay; 7) using higher dielectric constant material in the insulating overlay; or 8) verifying that there is no air-gap between the PC pad surface and the touching finger.

There is some variation of sensor element sensitivity as a result of environmental factors. A baseline update routine, which compensates for this variation, may be provided in the high-level APIs of the processing algorithms.

As described above with respect to the relaxation oscillator 350, when a finger or conductive object is placed on the sensor element, the capacitance increases from Cp to Cp+Cf so the relaxation oscillator output signal 356 (F_{OUT}) decreases. The relaxation oscillator output signal 356 (F_{OUT}) may be fed to a digital counter for measurement. There are two methods for counting the relaxation oscillator output signal 356: frequency measurement and period measurement. Additional details of the relaxation oscillator and digital counter are known by those of ordinary skill in the art, and accordingly a detailed description regarding them have not been included. It should also be noted, that the embodiments described herein are not limited to using relaxation oscillators, but may include other sensing circuitry for measuring capacitance, such as versus voltage phase shift measurement, resistor-capacitor charge timing, capacitive bridge divider, charge transfer, sigma-delta modulators, charge-accumulation circuits, or the like.

FIG. 3D illustrates a schematic of one embodiment of a circuit 375 including a sigma-delta modulator 360 and a digital filter 390 for measuring capacitance on a sensor element 351. Circuit 375 includes a switching circuit 370, switching clock source 380, sigma-delta modulator 360, and digital filter 390 for measuring the capacitance on sensor element 351. Sensor element 351 may be a sensor element of sensor array 410, and is represented as a switching capacitor Cx in the modulator feedback loop. Alternatively, sensor element 351 may be a single element, such as used in a touch-sensor button. Switching circuit 370 includes two switches Sw₁ 371 and Sw₂ 372. The switches Sw₁ 371 and Sw₂ 372 operate in two, non-overlapping phases (also known as break-before-make configuration). These switches together with sensing capacitor C_{X} 351 form the switching capacitor equivalent resistor, which provides the modulator capacitor C_{mod} 363 of sigma-delta modulator 360 charge current (as illustrated in FIG. 3D) or discharge current (not illustrated) during one of the two phases.

The sigma-delta modulator 360 includes the comparator 361, latch 362, modulator capacitor C_{mod} 363, modulator feedback resistor 365, which may also be referred to as bias resistor 365, and voltage source 366. The output of the comparator may be configured to toggle when the voltage on the modulator capacitor 363 crosses a reference voltage 364. The reference voltage 364 may be a pre-programmed value, and may be configured to be programmable. The sigma-delta modulator 360 also includes a latch 362 coupled to the output of the comparator 361 to latch the output of the comparator 361 for a given amount of time, and provide as an output, output 392. The latch may be configured to latch the output of the comparator based on a clock signal from the gate circuit 382 (e.g., oscillator signal from the oscillator 381). In another embodiment, the sigma-delta modulator 360 may include a synchronized latch that operates to latch an output of the comparator for a pre-determined length of time. The output of the comparator may be latched for measuring or sampling the output signal of the comparator 361 by the digital filter 390.

Sigma-delta modulator 360 is configured to keep the voltage on the modulator capacitor 363 close to reference voltage V_{ref} 364 by alternatively connecting the switching capacitor resistor (e.g., switches Sw₁ 371 and Sw₂ 372 and sensing capacitor C_{X} 351) to the modulator capacitor 363. The output 392 of the sigma-delta modulator 360 (e.g., output of latch 362) is feedback to the switching clock circuit 380, which controls the timing of the switching operations of switches Sw₁ 371 and Sw₂ 372 of switching circuit 370. For example, in this embodiment, the switching clock circuit 380 includes an oscillator 381 and gate 382. Alternatively, the switching clock circuit 380 may include a clock source, such as a spread spectrum clock source (e.g., pseudo-random signal (PRS)), a frequency divider, a pulse width modulator (PWM), or the like. The output 392 of the sigma-delta modulator 360 is used with an oscillator signal to gate a control signal 393, which switches the switches Sw₁ 371 and Sw₂ 372 in a non-overlapping manner (e.g., two, non-overlapping phases). The output 392 of the sigma-delta modulator 360 is also output to digital filter 430, which filters and/or converts the output into the digital code 391.

In one embodiment of the method of operation, at power on, the modulator capacitor 363 has zero voltage and switching capacitor resistor (formed by sensing capacitor Cx 351, and switches Sw₁ 371 and Sw₂ 372) is connected between Vdd line 366 and modulator capacitor 363. This connection allows the voltage on the modulator capacitor 363 to rise. When this voltage reaches the comparator reference voltage, V_{ref} 364, the comparator 361 toggles and gates the control signal 393 of the switches Sw₁ 371 and Sw₂ 372, stopping the charge current. Because the current via bias resistors R_{b} 365 continues to flow, the voltage on modulator capacitor 363 starts dropping. When it drops below the reference voltage 364, the output of the comparator 361 switches again, enabling the modulator 363 to start charging. The latch 362 and the comparator 361 set sample frequency of the sigma-delta modulator 360.

The digital filter 390 is coupled to receive the output 392 of the sigma-delta modulator 360. The output 392 of the sigma-delta modulator 360 may be a single bit bit-stream, which can be filtered and/or converted to the numerical values using a digital filter 390. In one embodiment, the digital filter 390 is a counter. In another embodiment, the standard Sinc digital filter can be used. In another embodiment, the digital filter is a decimator. Alternatively, other digital filters may be used for filtering and/or converting the output 392 of the sigma-delta modulator 360 to provide the digital code 391. It should also be noted that the output 392 may be output to the decision logic 402 or other components of the processing device 210, or to the decision logic 451 or other components of the host 250 to process the bitstream output of the sigma-delta modulator 360.

Described below are the mathematical equations that represent the operations of FIG. 3D. During a normal operation mode, the sigma-delta modulator 360 keeps these currents equal in the average by keeping the voltage on the modulator 363 equal to, or close to, the reference voltage V_{ref} 364. The current of the bias resistor R_{b} 365 is:

$${I}_{Rb} = \frac{{V}_{c mod}}{{R}_{b}} \qquad ( 5 )$$

The sensing capacitor Cₓ 351 in the switched-capacitor mode has equivalent resistance:

$${R}_{c} = \frac{1}{{f}_{s} {C}_{x}} \qquad ( 6 )$$

where fₛ is the operation frequency of the switches (e.g., switching circuit 370). If the output 392 of the sigma-delta modulator 360 has a duty cycle of d_{mod}, the average current of the switching capacitor 351 can be expressed in the following equation (7):

$$\begin{matrix}{I}_{c} = {d}_{mod} \frac{{V}_{dd} - {V}_{C mod}}{{R}_{c}} & ( 7 ) \\ In the operation mode , {I}_{Rb} = {I}_{c} , {V}_{C mod} = {V}_{ref} or \text{:} \frac{{V}_{ref}}{{R}_{b}} = {d}_{mod} \frac{{V}_{dd} - {V}_{ref}}{{R}_{c}} & ( 8 )\end{matrix}$$

or taking into account that the reference voltage 364 is part of supply voltage:

$${V}_{ref} = {k}_{d} {V}_{dd} ; {k}_{d} = \frac{{R}_{1}}{{R}_{1} + {R}_{2}} \qquad ( 9 )$$

The Equation (5) can be rewritten in the following form:

$${d}_{mod} = \frac{{R}_{c}}{{R}_{b}} \frac{{k}_{d}}{1 - {k}_{d}} = \frac{1}{{f}_{s} {R}_{b}} \frac{{k}_{d}}{1 - {k}_{d}} \frac{1}{{C}_{x}} \qquad ( 10 )$$

The Equation (10) determines the minimum sensing capacitance value, which can be measured with the proposed method at given parameters set:

$${d}_{mod} \leq 1 , or \text{:} {C}_{x min} = \frac{1}{{f}_{s} {R}_{b}} \frac{{k}_{d}}{1 - {k}_{d}} \qquad ( 11 )$$

The resolution of this method may be determined by the sigma-delta modulator duty cycle measurement resolution, which is represented in the following equations:

$$Δ {d}_{mod} = β \frac{Δ {C}_{x}}{{C}_{x}^{2}} ; \\ β = \frac{1}{{f}_{s} {R}_{b}} \frac{{k}_{d}}{1 - {k}_{d}} \qquad ( 12 )$$

or after rewriting relatively ΔCₓ, we obtain:

$$Δ {C}_{x} = \frac{1}{β} Δ {d}_{mod} {C}_{x}^{2} \qquad ( 13 )$$

In one exemplary embodiment, the resistance of the bias resistor 365 is 20K Ohms (R_{b}=20 k), the operation frequency of the switches is 12 MHz (fₛ=12 MHz), the capacitance on the switching capacitor 351 is 15 picofarads (Cₓ=15 pF), and the ratio between Vdd 366 and the voltage reference 364 is 0.25 (k_{d}=0.25), the duty cycle has a 12-bit resolution and the capacitance resolution is 0.036 pF.

In some embodiments of capacitive sensing applications, it may be important to get fast data measurements. For example, the modulator can operate at sample frequency 10 MHz (period is 0.1 microseconds (us)), for the 12-bit resolution sample, and digital filter as single-type integrator/counter the measurement time is approximately 410 us (e.g., 2¹²*0.1 us=410 us). For faster measurement speeds at same resolutions, other types of digital filters may be used, for example, by using the Sinc2 filter, the scanning time at the same resolution may be reduced approximately 4 times. To do this the sensing method should have suitable measurement speed. In one embodiment, a good measurement rate may be accomplished by using a double integrator as the digital filter 390.

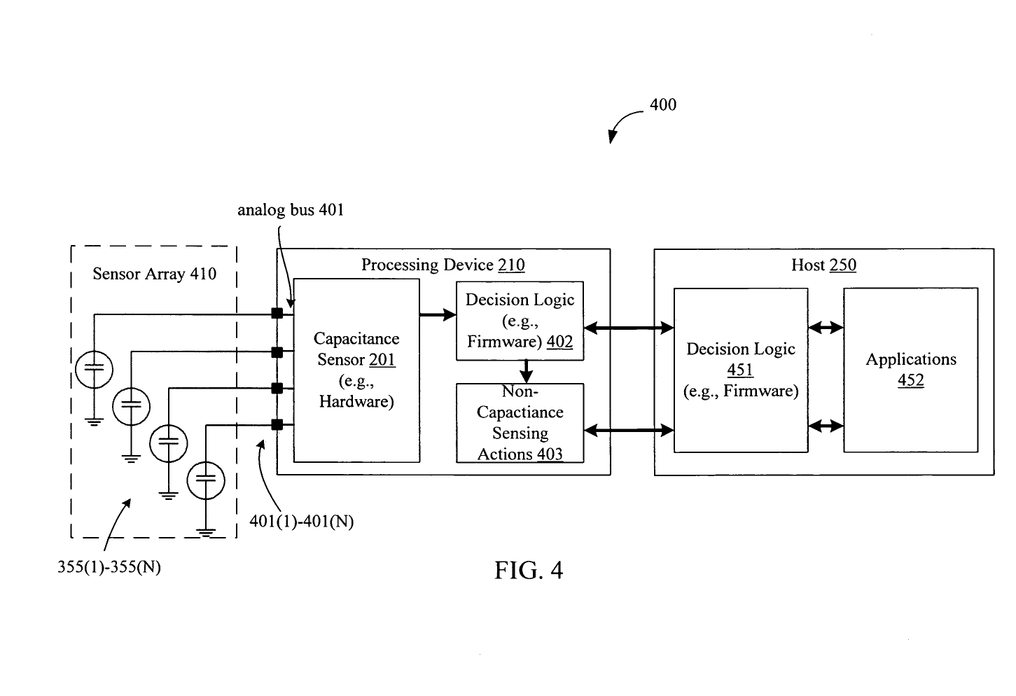

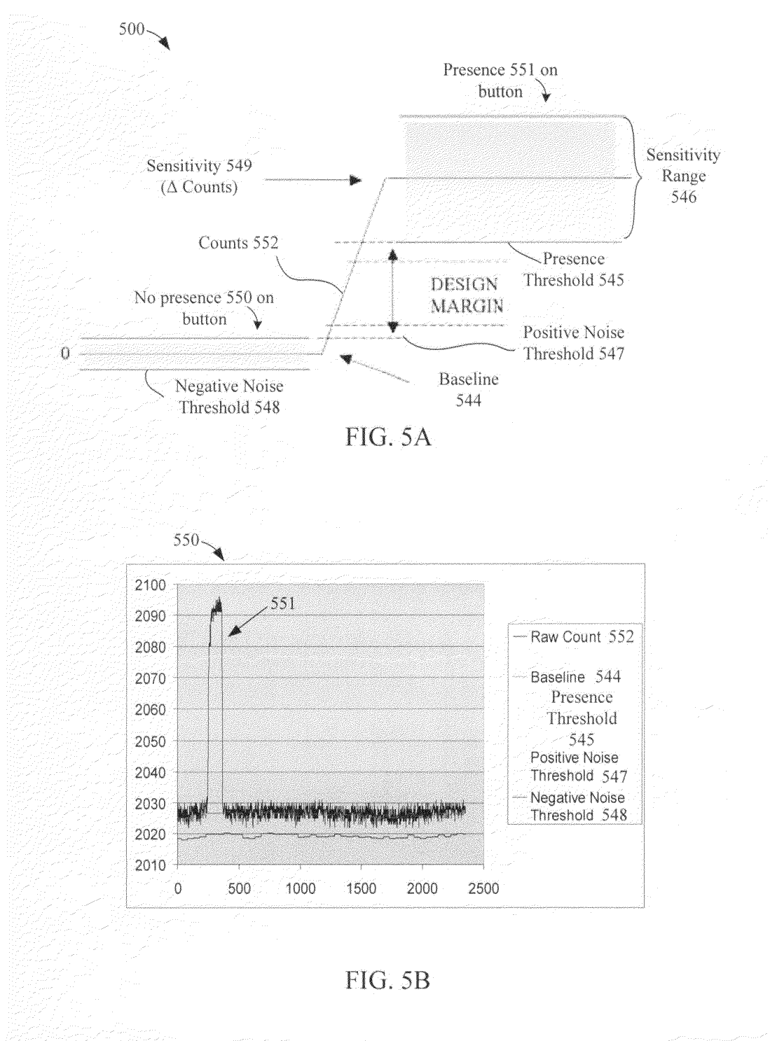

FIG. 4 illustrates a block diagram of one embodiment of an electronic device 400 including a processing device that includes capacitance sensor 201 for measuring the capacitance on a senor array 410. The electronic device 400 of FIG. 4 includes a sensor array 410, processing device 210, and host 250. Sensor array 410 includes sensor elements 355(1)-355(N), where N is a positive integer value that represents the number of rows (or alternatively columns) of the sensor array 410. Each sensor element is represented as a capacitor, as described above with respect to FIG. 3B. The sensor array 410 is coupled to processing device 210 via an analog bus 401 having multiple pins 401(1)-401(N). In one embodiment, the sensor array 410 may be a single-dimension sensor array including the sensor elements 355(1)-355(N), where N is a positive integer value that represents the number of sensor elements of the single-dimension sensor array. The single-dimension sensor array 410 provides output data to the analog bus 401 of the processing device 210 (e.g., via lines 231). Alternatively, the sensor array 410 may be a two-dimension sensor array including the sensor elements 355(1)-355(N), where N is a positive integer value that represents the number of sensor elements of the two-dimension sensor array. The two-dimension sensor array 410 provides output data to the analog bus 401 of the processing device 210 (e.g., via bus 221).

In one embodiment, the capacitance sensor 201 includes a selection circuit (not illustrated). The selection circuit is coupled to the sensor elements 355(1)-355(N) and the sensing circuitry of the capacitance sensor 201. Selection circuit may be used to allow the capacitance sensor to measure capacitance on multiple sensor elements (e.g., rows or columns). The selection circuit may be configured to sequentially select a sensor element of the multiple sensor elements to provide the charge current and to measure the capacitance of each sensor element. In one exemplary embodiment, the selection circuit is a multiplexer array. Alternatively, selection circuit may be other circuitry inside or outside the capacitance sensor 201 to select the sensor element to be measured. In another embodiment, one capacitance sensor 201 may be used to measure capacitance on all of the sensor elements of the sensor array. Alternatively, multiple capacitance sensors 201 may be used to measure capacitance on the sensor elements of the sensor array. The multiplexer array may also be used to connect the sensor elements that are not being measured to the system ground. This may be done in conjunction with a dedicated pin in to GP10 port 207.

In another embodiment, the capacitance sensor 201 may be configured to simultaneously sense the sensor elements, as opposed to being configured to sequentially scan the sensor elements as described above. For example, the sensing device may include a sensor array having multiple rows and columns. The rows may be sensed simultaneously, and the columns may be sensed simultaneously.

In one exemplary embodiment, the voltages on all of the rows of the sensor array are simultaneously varied, while the voltages of the columns are held at a constant voltage, with the complete set of sampled points simultaneously giving a profile of the conductive object in a first dimension. Next, the voltages on all of the rows are held constant, while the voltages on all the rows are simultaneously varied, to obtain a complete set of sampled points simultaneously giving a profile of the conductive object in the other dimension.

In another exemplary embodiment, the voltages on all of the rows of the sensor array are simultaneously varied in a positive direction, while the voltages of the columns are varied in a negative direction. Next, the voltages on all of the rows of the sensor array are simultaneously varied in a negative direction, while the voltages of the columns are varied in a positive direction. This technique doubles the effect of any transcapacitance between the two dimensions, or conversely, halves the effect of any parasitic capacitance to the ground. In both methods, the capacitive information from the sensing process provides a profile of the presence of the conductive object to the sensing device in each dimension. Alternatively, other methods for scanning known by those of ordinary skill in the art may be used to scan the sensing device.

In one embodiment, the processing device 210 further includes a decision logic block 402. The operations of decision logic block 402 may be implemented in firmware; alternatively, it may be implemented in hardware or software. The decision logic block 402 may be configured to receive the digital code or counts from the capacitance sensor 201, and to determine the state of the sensor array 410, such as whether a conductive object is detected on the sensor array, where the conductive object was detected on the sensor array (e.g., determining the X-, Y-coordinates of the presence of the conductive object), determining absolute or relative position of the conductive object, whether the conductive object is performing a pointer operation, whether a gesture has been recognized on the sensor array 410 (e.g., click, double-click, movement of the pointer, scroll-up, scroll-down, scroll-left, scroll-right, step Back, step Forward, tap, push, hop, zigzag gestures, or the like), or the like.

In another embodiment, instead of performing the operations of the decision logic 402 in the processing device 210, the processing device 201 may send the raw data to the host 250, as described above. Host 250, as illustrated in FIG. 4, may include decision logic 451. The operations of decision logic 451 may also be implemented in firmware, hardware, and/or software. Also, as described above, the host may include high-level APIs in applications 452 that perform routines on the received data, such as compensating for sensitivity differences, other compensation algorithms, baseline update routines, start-up and/or initialization routines, interpolations operations, scaling operations, or the like. The operations described with respect to the decision logic 402 may be implemented in decision logic 451, applications 452, or in other hardware, software, and/or firmware external to the processing device 210.

In another embodiment, the processing device 210 may also include a non-capacitance sensing actions block 403. This block may be used to process and/or receive/transmit data to and from the host 250. For example, additional components may be implemented to operate with the processing device 210 along with the sensor array 410 (e.g., keyboard, keypad, mouse, trackball, LEDs, displays, or the like).

At startup (or boot) the sensor elements (e.g., capacitors 355(1)-(N)) are scanned and the count values for each sensor element with no activation are stored as a baseline array (Cp). The presence of a finger on the sensor element is determined by the difference in counts between a stored value for no sensor element activation and the acquired value with sensor element activation, referred to here as Δn. The sensitivity of a single sensor element is approximately:

$$\frac{Δ n}{n} = \frac{Cf}{Cp} \qquad ( 14 )$$

The value of Δn should be large enough for reasonable resolution and clear indication of sensor element activation. This drives sensor element construction decisions. Cf should be as large a fraction of Cp as possible. Since Cf is determined by finger area and distance from the finger to the sensor element's conductive traces (through the over-lying insulator), the baseline capacitance Cp should be minimized. The baseline capacitance Cp includes the capacitance of the sensor element pad plus any parasitics, including routing and chip pin capacitance.

In sensor array applications, variations in sensitivity should be minimized. If there are large differences in Δn, one sensor element may activate at 1.0 cm, while another may not activate until direct contact. This presents a non-ideal user interface device. There are numerous methods for balancing the sensitivity. These may include precisely matching on-board capacitance with PCB trace length modification, adding balance capacitors on each sensor element's PCB trace, and/or adapting a calibration factor to each sensor element to be applied each time the sensor element is measured.

In one embodiment, the PCB design may be adapted to minimize capacitance, including thicker PCBs where possible. In one exemplary embodiment, a 0.062 inch thick PCB is used. Alternatively, other thicknesses may be used, for example, a 0.015 inch thick PCB.

Sliding sensor elements may be used for control requiring gradual or discrete adjustments. Examples include a lighting control (dimmer), volume control, graphic equalizer, and speed control. Slider controls may also be used for scrolling functions in menus of data. These sensor elements may be mechanically adjacent to one another. Activation of one sensor element results in partial activation of physically adjacent sensor elements. The actual position in the sliding sensor element is found by computing the centroid location of the set of sensor elements activated.

In applications for touch-sensor sliders (e.g., sliding sensor elements) and touch-sensor pads it is often necessary to determine finger (or other capacitive object) position to greater resolution than the native pitch of the individual sensor elements. The contact area of a finger on a sliding sensor element or a touch-pad is often larger than any single sensor element. In one embodiment, in order to calculate the interpolated position using a centroid, the array is first scanned to verify that a given sensor element location is valid. The requirement is for some number of adjacent sensor element signals to be above a noise threshold. When the strongest signal is found, this signal and those immediately adjacent are used to compute a centroid:

$$Centroid = \frac{{n}_{i - 1} \cdot ( i - 1 ) + {n}_{i} i + {n}_{i + 1} \cdot ( i + 1 )}{{n}_{i - 1} + {n}_{i} i + {n}_{i + 1}} \qquad ( 15 )$$

The calculated value may be fractional. In order to report the centroid to a specific resolution, for example a range of 0 to 100 for 12 sensor elements, the centroid value may be multiplied by a calculated scalar. It may be more efficient to combine the interpolation and scaling operations into a single calculation and report this result directly in the desired scale. This may be handled in the high-level APIs. Alternatively, other methods may be used to interpolate the position of the conductive object.

A physical touchpad assembly is a multi-layered module to detect a conductive object. In one embodiment, the multi-layer stack-up of a touchpad assembly includes a PCB, an adhesive layer, and an overlay. The PCB may include the processing device 210 and other components, such as the connector to the host 250, necessary for operations for sensing the capacitance. These components are on the non-sensing side of the PCB. The PCB also includes the sensor array on the opposite side; the sensing side of the PCB. Alternatively, other multi-layer stack-ups may be used in the touchpad assembly.

The PCB may be made of standard materials, such as FR4 or Kapton™ (e.g., flexible PCB). Alternatively, the PCB may be made of non-flexible PCB material. In either case, the processing device 210 may be attached (e.g., soldered) directly to the sensing PCB (e.g., attached to the non-sensing side of the PCB). The PCB thickness varies depending on multiple variables, including height restrictions and sensitivity requirements. In one embodiment, the PCB thickness is at least approximately 0.3 millimeters (mm). Alternatively, the PCB may have other thicknesses. It should be noted that thicker PCBs may yield improved sensitivity. The PCB length and width is dependent on individual design requirements for the device on which the sensing device is mounted, such as a notebook or mobile handset.

The adhesive layer may be directly on top of the PCB sensing array and is used to affix the overlay to the overall touchpad assembly. Typical material used for connecting the overlay to the PCB is non-conductive adhesive such as 3M 467 or 468. In one exemplary embodiment, the adhesive thickness is approximately 0.05 mm. Alternatively, the adhesive may be present on the bottom or back side of the overlay, and other thicknesses may be used.

The overlay may be non-conductive material used to protect the PCB circuitry from environmental conditions and ESD, and to insulate the user's finger (e.g., conductive object) from the circuitry. Overlay can be ABS plastic, polycarbonate, glass, or polyester film, such as Mylar™ polyester film. Alternatively, other materials known by those of ordinary skill in the art may be used. In one exemplary embodiment, the overlay has a thickness of approximately 1.0 mm. In another exemplary embodiment, the overlay thickness has a thickness of approximately 2.0 mm. Alternatively, other thicknesses may be used.

The sensor array may be a grid-like pattern of sensor elements (e.g., capacitive elements) used in conjunction with the processing device 210 to detect a presence of a conductive object, such as finger, to a resolution greater than that which is native. The touch-sensor pad layout pattern may be disposed to maximize the area covered by conductive material, such as copper, in relation to spaces necessary to define the rows and columns of the sensor array.

FIG. 5A illustrates a graph of a sensitivity of a single touch-sensor button. Graph 500 includes the counts 652 as measured on a single touch-sensor button for “no presence” 650 on the touch-sensor button, and for “presence” 651 on the touch-sensor button. “No presence” 650 is when the sensing device does not detect the presence of the conductive object, such as a finger. “No presence” 650 is detected between a range of noise. The range of noise may include a positive noise threshold 647 and a negative noise threshold 648. So long as the counts 652 are measured as being between the positive and negative thresholds 647 and 648, the sensing device detects “no presence” 650. “Presence” 651 is when the sensing device detects the presence of the conductive object (e.g., finger). “Presence” 651 is detected when the counts 652 are greater than a presence threshold 645. The presence threshold 645 indicates that a presence of a conductive object is detected on the sensing device. The sensitivity 649 (Cf/Cp) of the single button operation is such that when it detects the presence of the conductive object, the capacitance variation (Δn) is above the presence threshold 645. The sensitivity 649 may have a range, sensitivity range 646. Sensitivity range 646 may have a lower and upper limit or threshold. The lower threshold is equal to or greater than the presence threshold 645, allowing a “presence” 651 to be detected on the touch-sensor button. The sensing device may be configured such that there is a design margin between the presence threshold 645 and the positive noise threshold 647. The sensitivity range 646 is based on the surface area of the touch-sensor button.

FIG. 5B illustrates a graph of capacitance measured on a single touch-sensor button. Graph 675 illustrates the measured capacitance as raw counts 652, as well as the baseline 644, the presence threshold 645, positive noise threshold 647, and the negative noise threshold 648. As illustrated in graph 675, the raw counts 652 increase above the presence threshold 645, which is at approximately 2075 counts, the presence of the finger is detected on the sensing device. Although the presence threshold 645 is illustrated as being at 2075, and the baseline at 2025, other values may be used.

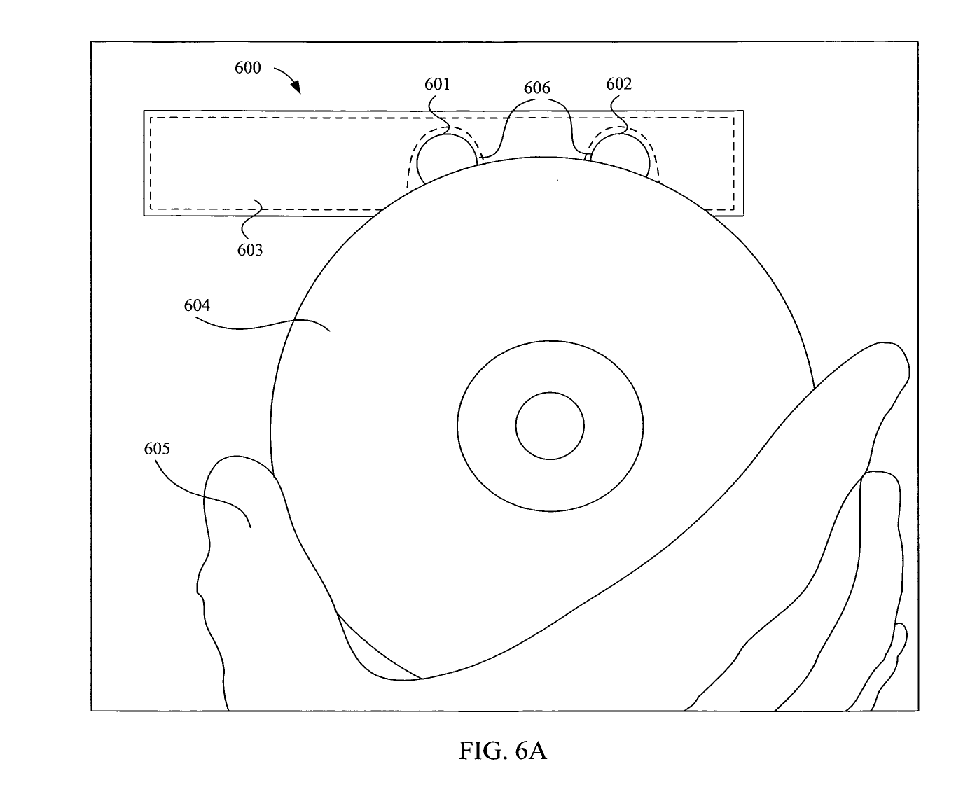

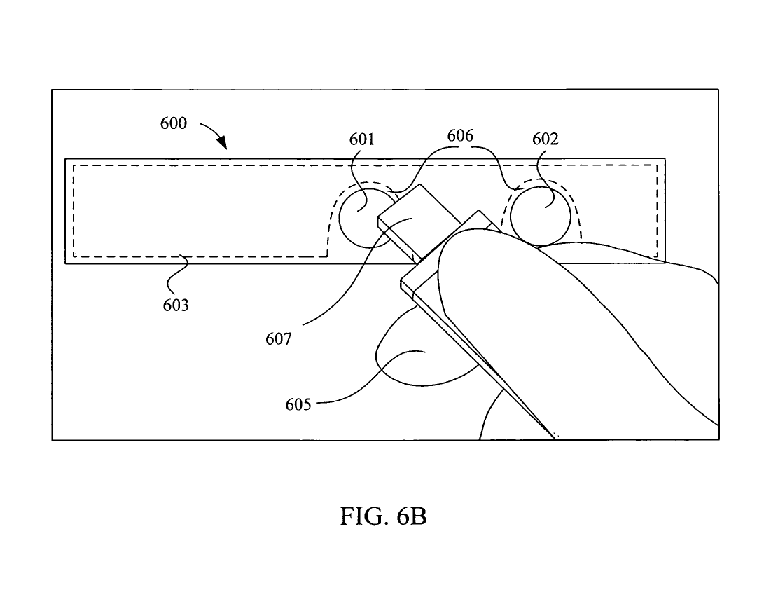

FIG. 6A illustrates a top-side view of one embodiment of a sensing device 600 having two touch-sensor buttons 601 and 602 and a guard sensor 603 to prevent an unintentional activation of the touch-sensor buttons 601 and 602 by a disc 604. The touch-sensor buttons 601 and 602 each include a sensor element that are used by the processing device 210 to detect the presence of a conductive object on the touch-sensor button. In this embodiment, the hand 605 of the user holds the disc 604, and as the user moves the disc 604 to be in close proximity to the sensing device 600, the disc 604 may activate the touch-sensor buttons 601 and 602. The sensor elements that correspond to the touch-sensor buttons 601 and 602 may be measured by the processing device 210. The sensing device 600, unlike the conventional sensing devices, includes the guard sensor 603 to prevent unintentional activations of the touch-sensor buttons 601 and 602 by the disc 604. The guard sensor 603 may be an additional sensor element in addition to the sensor elements that correspond to the touch-sensor buttons 601 and 602. Like the sensor elements that correspond to the touch-sensor buttons 601 and 602, the guard sensor 603 is made of conductive material. The guard sensor 603 is also coupled to the processing device 210 on a capacitance sensing pin 306. The processing device 210 may also be configured to measure the capacitance on the guard sensor 603. In one embodiment, the processing device 210 is configured to couple the guard sensor 603 and the sensor elements that correspond to the touch-sensor buttons 601 and 602, and to measure the capacitance on the all the sensor elements and the guard sensor. In another embodiment, a guard sensor is not used, and the processing device 210 is configured to couple all the sensor elements, or some of the sensor elements, together and scan them to determine a total capacitance on these sensor elements. In effect by coupling some or all of the sensor elements and scanning them, the touch panel operates as a virtual guard sensor to detect unintentional activations by a conductive object. In one embodiment, the touch panel that is configured to operate as a virtual guard includes six or more touch-sensor buttons. Alternatively, other numbers of touch-sensor buttons may be used. This may allow the embodiments to be employed in existing circuits without modifying the printed circuit board to add the additional sensor element (e.g., guard sensor). In another embodiment, the processing device 210 is configured to separately measure the capacitance on each of the sensor elements and the guard sensor 603.

The processing device 210 may be configured to detect the presence of the disc 604 using the guard sensor 603, as the disc 604 comes into close proximity of the touch-sensor buttons 601 and 602. Once the sensing device 600 has detected the presence of the disc 604 using the guard sensor 603, subsequent activations of the touch-sensor buttons 601 and 602 are ignored or prevented. Alternatively, the processing device 210 is configured to detect a presence of the disc 604 using the guard sensor and the sensor elements that correspond to the touch-sensor buttons 601 and 602.

In this embodiment, inherent capacitance of the disc 604 due the physical bulk of the disc 604 causes the unintentional activations of either of the touch-sensor buttons 601 and 602. Alternatively, a conductive object may be unintentionally brushed over or placed in close proximity to the sensor element of a touch-sensor button to cause the unintentional activation of the touch-sensor button.

In this embodiment, the conductive object that causes the unintentional activations of the touch-sensor buttons is a disc, such as a DVD or a CD. Alternatively, other conductive objects may cause the unintentional activations, such as the hand 605, a metal ruler, a thumb drive, a key, a dongle, a connector, a lighter, or the like. Alternatively, the sensing device may be configured to detect a finger or a thumb, and prevent any unintentional activation by the finger or thumb until the presence of the finger or thumb is greater than a button press threshold on one of the sensor elements of the touch-sensor buttons 601 and 602.

In one embodiment, the conductive object has a surface area that is approximately four to six times a surface area of one of the sensor elements that correspond to the touch-sensor buttons 601 and 602. Alternatively, the surface are of the conductive object may be more or less than the surface area of one of the sensor elements that correspond to the touch-sensor buttons 601 and 602. The guard sensor is typically configured for higher sensitivity than the main user input capacitance sensor elements. This may be achieved by making the physical size (e.g., surface area) of the guard sensor larger (e.g., 2-3 times) than the main user input sensor elements. Alternatively, if space constraints prevent this, higher sensitivity can be achieved by scanning the guard sensor for a longer period of time or by processing gains implemented in the capacitance sensor 201 and/or processing core 202. In one embodiment, the guard sensor is approximately two times larger in surface area than the main user input sensor elements. In another embodiment, the guard sensor is approximately three times larger in surface area than the main user input sensor elements. Alternatively, other sizes of the guard sensor and the main user input sensor elements may be used.

In one embodiment, the guard sensor 603 is disposed between the sensor elements that correspond to the touch-sensor buttons 601 and 602. In another embodiment, the guard sensor 603 is disposed to substantially surround the sensor elements that correspond to the touch-sensor buttons 601 and 602, as illustrated in FIG. 6A. Alternatively, the guard sensor 603 may be disposed to partially surround or completely surround the sensor elements that correspond to the touch-sensor buttons 601 and 602.

The sensing device 600 also includes an insulation area 606 of non-conductive material. The insulation area 606 is disposed between the guard sensor 603 and the other sensor elements. In this embodiment, the insulation area 606 is disposed so that the guard sensor 603 is disposed to substantially surround the sensor elements, instead of completely surrounding the sensor elements. In one embodiment, the insulation area 606 provides an area where a finger or conductive object can intentionally activate the touch-sensor buttons 601 and 602, without activating the guard sensor 603. In one embodiment, the area is the width of the sensor element of each of the touch-sensor buttons 601 and 602. Alternatively, other widths and dimensions for this area may be used. In one embodiment, the insulation area 606 is optimized to allow for presses that are not strictly 90 degree oblique to the touch panel, yet still reject accidental presses from foreign objects. Alternatively, the guard sensor may be disposed in other locations with respect to the other sensor elements.

Although the embodiments above are described with respect to the disc 604 as the conductive object, other conductive objects may be prevented from unintentionally activating the touch-sensor buttons 601 and 602.

Although the sensing device 600 of FIG. 6A is illustrated as having two touch-sensor buttons of a touch panel, the sensing device 600 may include more or less touch-sensor buttons and may be implemented in other applications other than a touch panel, such as a touchpad or touch-sensor slider. In one embodiment, the sensing device is implemented in a control panel of a device, such as a control panel of a gaming device or a computer. In another embodiment, the sensing device is implemented in a mobile handset, such as a cellular phone. Alternatively, the sensing device, including the guard sensor, may be implemented in other electronic devices that include one or more touch-sensor buttons.

FIG. 6B illustrates a top-side view of one embodiment of a sensing device 600 having two touch-sensor buttons 601 and a guard sensor 603 to prevent an unintentional activation of the touch-sensor buttons 601 and 602 by a thumb drive 607. The sensing device 600 of FIG. 6B is similar to the sensing device of FIG. 6A, except in this embodiment, the sensing device 600 prevents an unintentional activation of the touch-sensor buttons 601 and 602 by the thumb drive 607. The processing device 210 may be configured to detect the presence of the thumb drive 607 using the guard sensor 603, as the thumb drive 607 comes into close proximity of the touch-sensor buttons 601 and 602. Once the sensing device 600 has detected the presence of the thumb drive 607 using the guard sensor 603, subsequent activations of the touch-sensor buttons 601 and 602 are ignored or prevented. Alternatively, the processing device 210 is configured to detect a presence of the thumb drive 607 using the guard sensor and the sensor elements that correspond to the touch-sensor buttons 601 and 602.

In this embodiment, inherent capacitance of the thumb drive 607 due the physical bulk of the thumb drive 607 causes the unintentional activations of either of the touch-sensor buttons 601 and 602. Alternatively, a thumb drive 607 may be unintentionally brushed over or placed in close proximity to the sensor element of a touch-sensor button to cause the unintentional activation of the touch-sensor button.

In this embodiment, the conductive object that causes the unintentional activations of the touch-sensor buttons is a thumb drive. Alternatively, other conductive objects may cause the unintentional activations, such as the hand 605, a metal ruler, a key, a dongle, a connector, a lighter, or the like. Alternatively, the sensing device may be configured to detect a finger or a thumb, and prevent any unintentional activation by the finger or thumb until the presence of the finger or thumb is greater than a button press threshold on one of the sensor elements of the touch-sensor buttons 601 and 602.

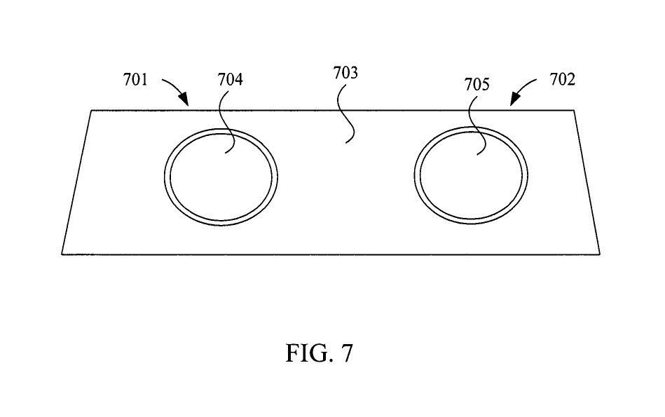

FIG. 7 illustrates one embodiment of two touch-sensor buttons 701 and 702 of a sensing device 700, each having recessed sensor elements to prevent an unintentional activation of the touch-sensor buttons 701 and 702. The touch-sensor buttons 701 and 702 each include a sensor element 703 and 704, respectively, that are used by the processing device 210 to detect the presence of a conductive object on the touch-sensor buttons 701 and 702. The sensing device 700 also includes a button housing 703 for the recessed sensor elements 704 and 705. The sensor elements 704 and 705 are recessed from a surface of the button housing 703. The button housing 703 operates as a non-conductive guard to prevent conductive objects other than the activating object from being in close proximity to the sensor elements 704 and 704, preventing the unintentional activation of the touch-sensor buttons 701 and 702. Recessing the sensor elements by approximately 0.3 mm to 1.0 mm, for example, may adequately reject large foreign objects, such as CDs/DVDs, by preventing such object from physically touching the surface of the protected touch sensor elements.

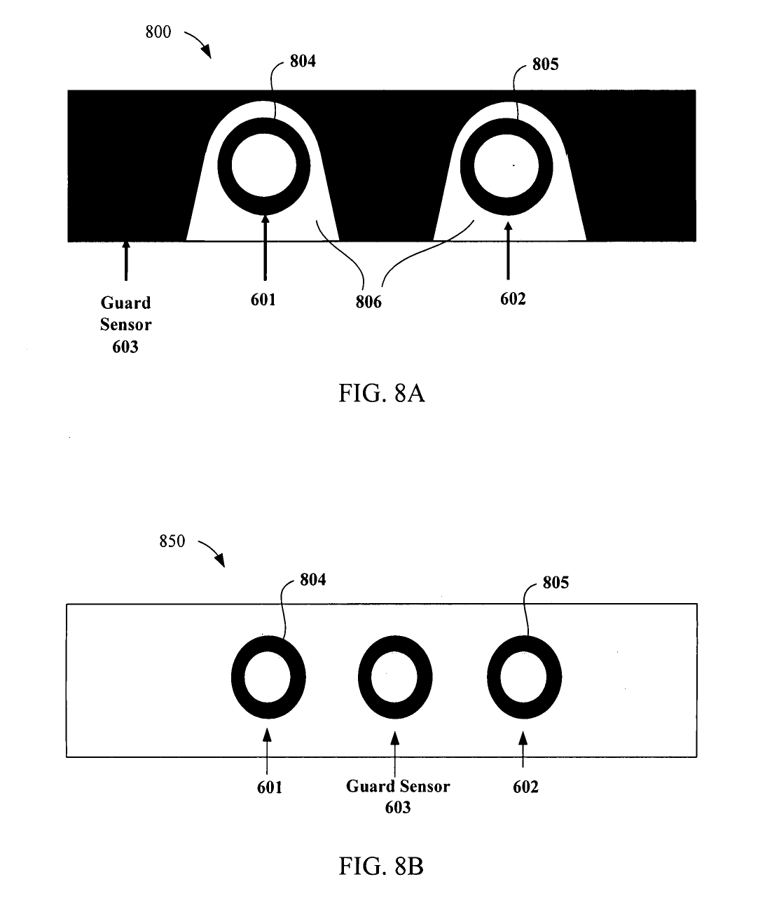

FIG. 8A illustrates a bottom-side view of one embodiment of a guard sensor 603 disposed to substantially surround two touch-sensor buttons 601 and 602 of a sensing device 800. The touch-sensor buttons 601 and 602 each include a sensor element 804 and 805, respectively, which are used by the processing device 210 to detect the presence of the conductive object on the touch-sensor buttons 601 and 602. The guard sensor 603 is also a sensor element that is coupled to the processing device 210. The processing device 210 is configured to measure a capacitance on either the guard sensor 603 or on the guard sensor 603 and the other sensor elements 804 and 805 to determine the presence of the conductive object. If the capacitance is over a rejection threshold, the activations of the touch-sensor buttons 601 and 602 are ignored, preventing the unintentional activations of the touch-sensor buttons 601 and 602.

In this embodiment, the guard sensor 603 is disposed to surround the sensor elements 804 and 805 that correspond to the touch-sensor buttons 601 and 602, respectively. The sensing device 600 also includes an insulation area 806 of non-conductive material. The insulation area 806 is disposed between the guard sensor 603 and the other sensor elements 804 and 805. In particular, the insulation area 806 is disposed so that the guard sensor 603 is disposed to substantially surround the sensor elements 804 and 805, instead of completely surrounding the sensor elements. In one embodiment, the insulation area 806 provides an area where a finger or conductive object can intentionally activate the touch-sensor buttons 601 and 602, without activating the guard sensor 603. In one embodiment, the area is the width of the sensor element 804 and 805 of each of the touch-sensor buttons 601 and 602. Alternatively, other widths and dimensions for this area may be used. In one embodiment, the insulation area 806 is optimized to allow for presses that are not strictly 90 degree oblique to the touch panel, yet still reject accidental presses from foreign objects. This configuration may ensure normal usage for finger presses, without being rejected by the guard sensor 603. Alternatively, the guard sensor 603 may be disposed in other locations with respect to the other sensor elements.

Although the guard sensor 603 is illustrated and described as being disposed to substantially surround the sensor elements 804 and 805, alternatively, the guard sensor may be disposed to partially or completely surround the sensor elements 804 and 805, or disposed between the sensor elements, as illustrated in FIG. 8A.

FIG. 8B illustrates a bottom-side view of one embodiment of a guard sensor 603 disposed between two touch-sensor buttons 601 and 602 of a sensing device 850. The sensing device 850 is similar to the sensing device 800 of FIG. 8A, except the guard sensor 603 is an additional sensor element disposed between the two touch-sensor buttons 601 and 602, instead of disposed to substantially surround the two touch-sensor buttons 601 and 602. In this embodiment, the guard sensor 603 is of similar dimension and shape as the sensor elements 804 and 805. Alternatively, the guard sensor 603 may have dissimilar dimensions and/or dissimilar shapes as the sensor elements 804 and 805.

In this embodiment, the three sensor elements (603, 804, and 805) are coupled to the processing device 210 (e.g., via capacitance sensing pins 306). The processing device 210 is configured to either measure a capacitance on each of the sensor elements or a collective capacitance on all the sensor elements (e.g., by coupling the three sensor elements together when measuring). The processing device 210 determines if the capacitance is greater than a rejection threshold. If the capacitance is greater than the rejection threshold, the processing device 210 may prevent any unintentional activation of the touch-sensor buttons 601 and 602.

The sensor elements of FIGS. 8A and 8B have been illustrated as rings, having an outer ring of conductive material with an inside of non-conductive material. This is commonly done to allow LED or other backlighting methods to pass through the capacitance sensors to illuminate the touch panel user interface graphics (e.g. key legends). Alternatively, the sensor elements of FIGS. 8A and 8B may be other shapes, such as circular, square, rectangular, semi-circular, oval, diamond, hexagonal, pentagonal, octagonal, or the like. Transparent conductive materials such as Indium Tin Oxide (ITO), organic polymers such as Polyethylenedioxythiophene (PEDOT) Polypyrrole, Polyaniline or the like, or other transparent polymers that allow backlight to propagate through them can be used without the need for cutouts as described above.

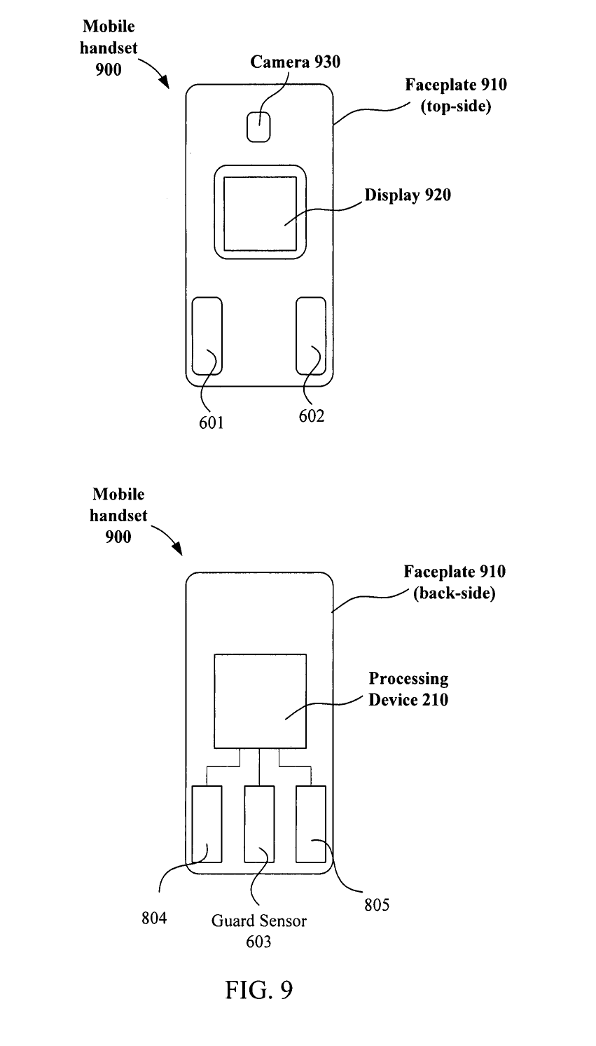

FIG. 9 illustrates a top-side view and a bottom-side view of one embodiment of a case 910 of a mobile handset 900 having two touch-sensor buttons 601 and 602 and a guard sensor 603 to prevent an unintentional activation of the touch-sensor buttons 601 and 602. The top-side view illustrates the case 910 (e.g., faceplate or outside housing of the mobile handset 90), which includes openings for a display 920, a camera 930, and touch-sensor buttons 601 and 602. The display 920 may be configured to display text, images, and/or video. The camera 930 may be configured to capture images and/or video. The touch-sensor buttons 601 and 602 are configured to be input buttons for the mobile handset 900. The camera 930 and display 920 are known by those of ordinary skill in the art, and accordingly, a detailed description regarding their operation has not been included. The touch-sensor buttons 601 and 602 operate similarly to the touch-sensor buttons described herein. The back-side view illustrates the case 910 to which the processing device 210, sensor elements 804 and 805, and guard sensor 603 are coupled. It should be noted that the mobile handset 900 may include additional components that are known by those of ordinary skill in the art, and may include less components than illustrated in FIG. 9, such as the display 920 or camera 930.

Sensor elements 804 and 805 and guard sensor 603 are coupled to the processing device 210 (e.g., via capacitance sensing pins 306 of processing device 210), using for example, wires or conductive traces. In one embodiment, the processing device 210, sensor elements 804 and 805, and guard sensor 603 are disposed on a common substrate, for example, a substrate of a printed circuit board. Alternatively, the processing device 210, sensor elements 804 and 805, and guard sensor 603 is disposed in other configurations, such as the processing device on one substrate and the sensor elements (804, 804, and 603) are disposed on another substrate or directly on the case 910.

Although guard sensor 603 is illustrated as a sensor element having similar shape and dimensions to the sensor elements 804 and 805, the guard sensor 603 may have other dimensions and/or shapes than the sensor elements 804 and 805. Similarly, although guard sensor 603 is illustrated as a sensor element disposed between the sensor elements 804 and 805, the guard sensor 603 may be disposed in other configurations, such as disposed to partially surround, substantially surround, or completely surround the sensor elements 804 and 805.

Using this embodiment, as a conductive object is placed in proximity to the mobile handset 900, the processing device 210 may prevent the unintentional activations of the touch-sensor buttons 601 and 602. For example, placing the mobile handset 900 close to the face of a user does not cause an unintentional activation of the touch-sensor buttons 601 and 602, unlike the conventional sensing devices. Similarly, placing the mobile handset 900 in a pocket of an article of clothing of a user does not cause an unintentional activation of the touch-sensor buttons 601 and 602.

In one embodiment, the mobile handset 900 may include an operation (e.g., turn on camera 930) that can be activated by activating both touch-sensor buttons 601 and 602 simultaneously. However, without a guard sensor 603 this operation may be unintentionally activated when the mobile handset 900 is placed face down on a conductive surface, or alternatively, is placed in a user's pocket. Using the guard sensor 603, the processing device 210 may determine that the guard sensor 603 has been activated in addition to the touch-sensor buttons 601 and 602, and consequently, ignore the unintentional activations of the touch-sensor buttons 601 and 602 by the conductive surface or the user's pocket. In this embodiment, the guard sensor 603 is located between the sensor elements 804 and 805 of the touch-sensor buttons 601 and 602 to reject any object that covers the entire sensor area, but to allow any intentional activations of both the touch-sensor buttons 601 and 602, such as by two fingers. Alternatively, the guard sensor 603 may be other sizes and be disposed in other locations to prevent the unintentional activation of one or more touch-sensor buttons by a conductive object, while allowing the intentional activations of the touch-sensor buttons.

In one embodiment, the guard sensor 603 is configured to detect a presence of a conductive object (e.g., finger) within approximately six to eight millimeters (6-8 mm) of the touch-sensor button. Alternatively, the guard sensor 603 may be configured to detect a presence of a conductive object within less than six millimeters or further away than eight millimeters.

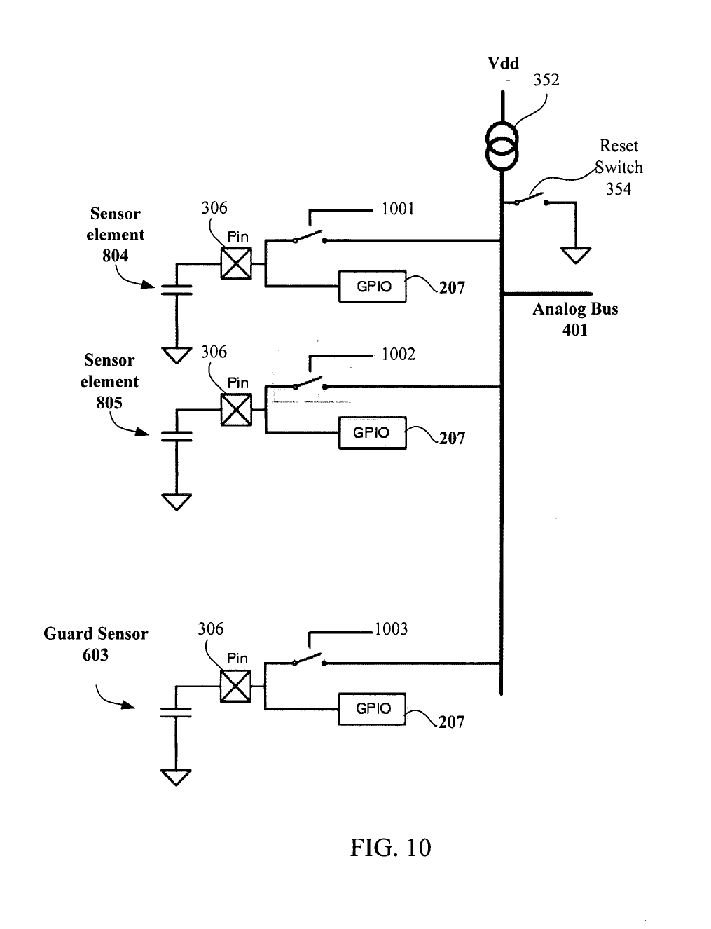

FIG. 10 illustrates one embodiment of a selection circuit 430 coupled to an analog bus 401 for measuring capacitance on the sensor elements 804 and 805 and the guard sensor 603. As previously described, the selection circuit 430 is coupled to the sensor elements (e.g., 804, 805, and guard sensor 603) via capacitance sensing pins 306, current source 352, reset switch 354, and a comparator 353 (not illustrated) via analog bus 401. The selection circuit 430 may be configured to sequentially select a sensor element of the multiple sensor elements 804, 805, and 603 to provide the charge current and to measure the capacitance of each sensor element 804, 805, and 603. In one exemplary embodiment, the selection circuit 430 is a multiplexer array of the relaxation oscillator 350. Alternatively, selection circuit 430 may be other circuitry outside the relaxation oscillator 350, or even outside the capacitance sensor 201 to select the sensor element to be measured. The selection circuit 430 may also be used to ground the sensor elements that are not being measured. This may be done in conjunction with a dedicated pin in the GP10 port 207. The selection circuit 430 may also be used to couple all the sensor elements 804, 805, and/or 603 at the same time. When the sensor elements 804, 805, and 603 are coupled together the processing device 210 may be configured to measure the capacitance on all three sensor elements. Alternatively, the processing device 210 may sequentially or simultaneously scan each of the sensor elements individually. The processing device 210 can select the sensor elements 804, 805, and 603 using selection control lines 1001, 1002, and 1003, respectively.

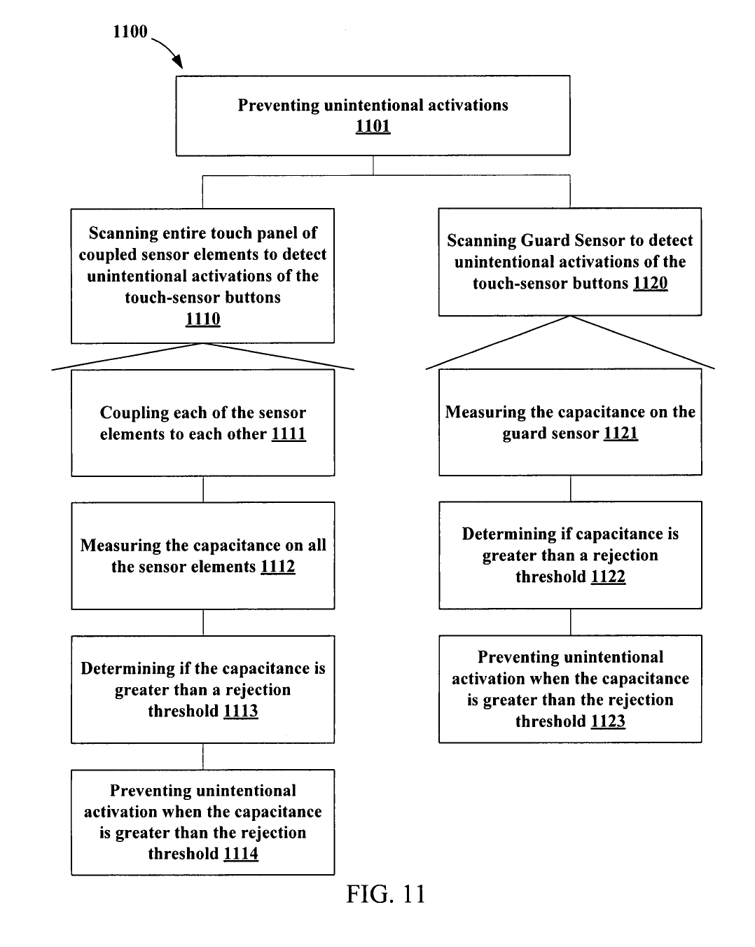

FIG. 11 illustrates two embodiments of a method 1100 of preventing unintentional activations of the touch-sensor buttons. The method 1100 includes detecting a presence of a conductive object by a touch panel that includes one or more touch-sensor buttons. The one or more touch-sensor buttons each include a corresponding sensor element. Method 1100 further includes preventing unintentional activation of the one or more touch-sensor buttons caused by the conductive object using the either the one or more sensor elements or using an additional sensor element, operation 1101. The additional sensor element is the guard sensor 603, as described herein.

In one embodiment, preventing the unintentional activations of operation 1101 may be performed by using the one or more sensor elements. This embodiment includes scanning the entire touch panel of coupled sensor elements to detect unintentional activations of the touch-sensor buttons, operation 1110. In another embodiment, preventing the unintentional activations of operation 1101 may be performed by using the guard sensor 603, operation 1120.

Scanning the entire touch panel of coupled sensor elements of operation 1110 may further include coupling all (or some of) the sensor elements to each other, operation 1111, and measuring the capacitance on all the coupled sensor elements, operation 1112. This embodiment further includes determining if the capacitance on all the sensor elements is greater than a rejection threshold, operation 1113, and preventing unintentional activation when the capacitance is greater than the rejection threshold, operation 1114.

Scanning the guard sensor 603 of operation 1120 may further include measuring the capacitance on the guard sensor 603, operation 1121. This embodiment further includes determining if the capacitance on the guard sensor 603 is greater than a rejection threshold, operation 1122, and preventing unintentional activation when the capacitance is greater than the rejection threshold, operation 1123.

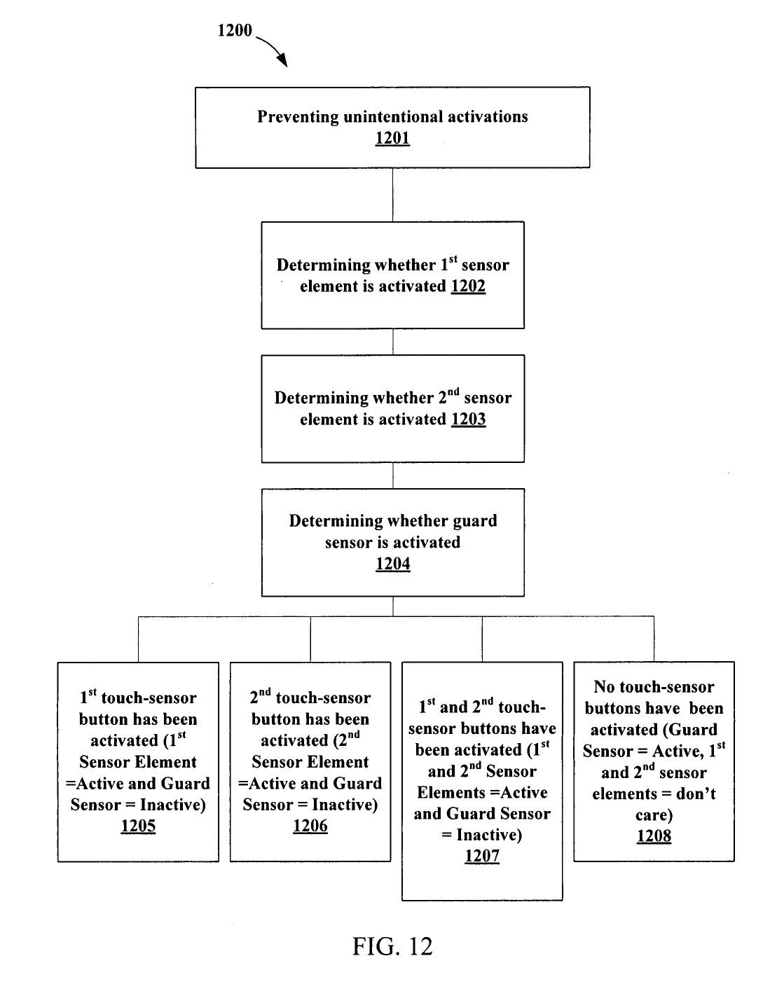

FIG. 12 illustrates one embodiment of a method of preventing unintentional activations of the first and second touch-sensor buttons 601 and 602 using a guard sensor 603. Method 1200 also includes preventing unintentional activation of the touch-sensor buttons 601 and 602 caused by the conductive object using an additional sensor element, operation 1201. Similarly, the additional sensor element is the guard sensor 603. This embodiment includes determining whether the first sensor element 804, the second sensor element 805, and/or the guard sensor 603 has been activated, operations 1202-1204. The first touch-sensor button 601 has been activated when the first sensor element 804 is activated and the guard sensor 603 is not activated, operation 1205. The second touch-sensor button 602 has been activated when the second sensor element 805 is activated and the guard sensor 603 is not activated. The first and second touch-sensor buttons 601 and 602 have been activated when the first and second sensor elements 804 and 805 are activated and the guard sensor 603 is not activated. The touch-sensor buttons 601 and 602 are not activated when the guard sensor 603 is activated, regardless of whether the sensor element 804 has been activated and regardless of whether the sensor element 805 has been activated. The method may further include determining that neither of the touch-sensor buttons 601 and 602 have been activated when the first and second sensor elements 804 and 805 are not activated, regardless of whether the guard sensor 603 is activated or not.

In one embodiment, the gain or sensitivity of the guard sensor 603 is optimized in the processing device 210 to ensure that foreign objects are rejected while intended button presses are accepted. For example, a longer scan time and lower threshold can be set in the processing device 210 to increase the resolution of the guard sensor 603. Alternatively, the processing device 210 may be configured to decrease the resolution of the guard sensor 603 and increase the resolution of the other sensor elements. In one embodiment, the firmware of the processing device 210 is used in conjunction with the configuration (e.g., size and placement) of the guard sensor to prevent the unintentional activation of the touch-sensor buttons of the sensing device.

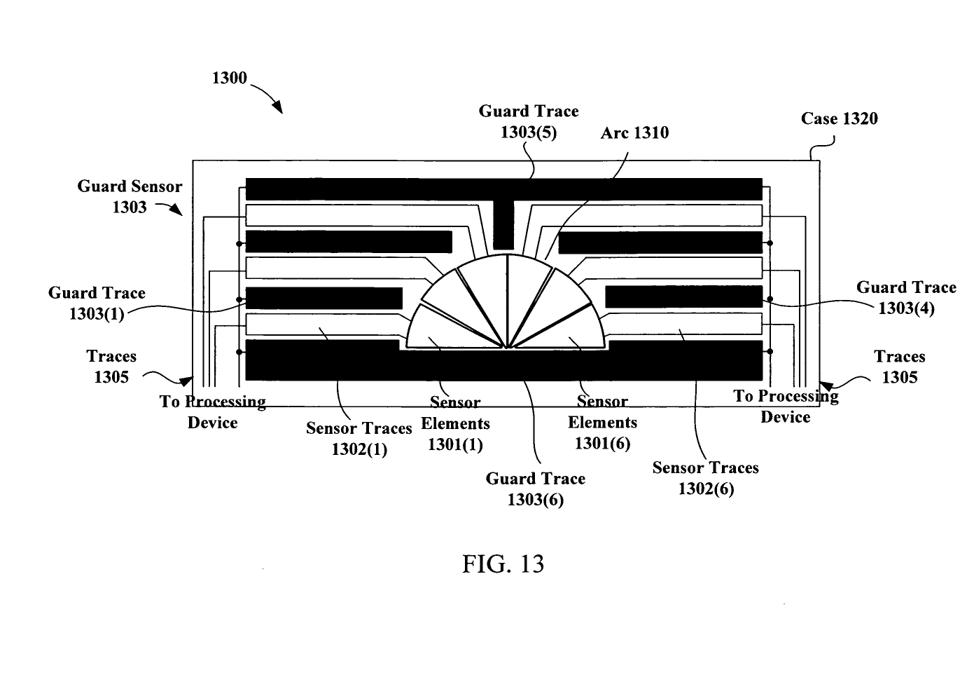

FIG. 13 illustrates a radial slider 1300 having multiple sensor elements 1301(1)-(6) coupled to a processing device via sensor traces 1302(1)-(6), and a guard sensor 1303 disposed outside an arc 1310 of the radial slider 1300 to prevent unintentional activations of the multiple sensor elements 1301(1)-(6) by a conductive object outside of the arc 1310. Each sensor element 1301 is coupled to a sensor trace 1302. Each sensor trace 1302 is coupled to one of the traces 1305, which are coupled to the processing device 210. In one embodiment, the sensor elements 1301(1)-(6) are routed to a side of a case 1320 that houses the radial slider and the processing device 210, such as a mobile handset, or other electronic device.

The guard sensor 1303 is disposed outside the arc 1310 to prevent the unintentional activations of the multiple sensor elements 1301(1)-(6) by a conductive object outside of the arc 1310. In one embodiment, the guard sensor 1303 includes interleaved sensor traces, namely guard traces 1303(1)-(4). The guard traces 1303(1)-(6) are disposed between the sensor traces 1302(1)-(6) outside the arc 1310 of sensor elements 1301(1)-(6). In another embodiment, additional guard traces may be used, such as above the sensor elements, illustrated as the guard trace 1303(5), below the sensor elements 1301(1)-(6), illustrated as the guard trace 1303(6).

In one embodiment, the guard traces 1303(1)-(6) are coupled together and are coupled to one of the traces 1305, which is coupled to a pin of the processing device. In another embodiment, the guard traces 1303(1)-(6) are each individually coupled to a pin of the processing device. Alternatively, other combinations of coupling may be used to couple the guard sensor to one or more pins of the processing device.

In one embodiment, the guard sensor 1303 (e.g., guard traces 1303(1)-(6)) are disposed to prevent slider operations if a conductive object is detected outside the arc 1310. In another embodiment, the guard sensor 1303 (e.g., guard traces 1303(1)-(6)) are disposed to prevent slider operations if a conductive object is detected inside the arc 1310. Alternatively, the guard sensor 1303 (e.g., guard traces 1303(1)-(6)) are disposed to prevent slider operations if a conductive object is detected inside and outside the arc 1310.

In one embodiment, the guard sensor 1303 includes a guard trace 1303(8) that is sized and/or calibrated to prevent unintentional activation of the sensor elements 1301(1)-(6) by a conductive object that is larger than a finger. Alternatively, the guard trace 1303(6) is configured to reject activations of the sensor elements 1301(1)-(6) when a conductive object is detected within the arc 1310.

In one embodiment, the sensor elements 1301(1)-(6) and the guard traces 1303(1)-(6) are disposed on the same layer of sensing device assembly (e.g., same layer of a printed circuit board). Alternatively, the sensor elements 1301(1)-(6) and the guard traces 1303(1)-(6) are disposed on separate layers of the sensing device. In one embodiment, the main sensor area of the sensing device is a single-sided conductive material, such as copper, silver, ITO, PEDOT, or the like. Alternatively, the sensing device is implemented in multiple layers.

In one embodiment, when a conductive object is detected in the sensor area of the sensor elements 1301(1)-(6), represented by the arc 1310, a navigation function is performed by the processing device. When the conductive object is detected outside the sensor area represented by the arc 1310, the guard sensor 1303 prevents the unintentional activations of the sensor elements 1301(1)-(6) and the corresponding sensor traces 1302(1)-(6).

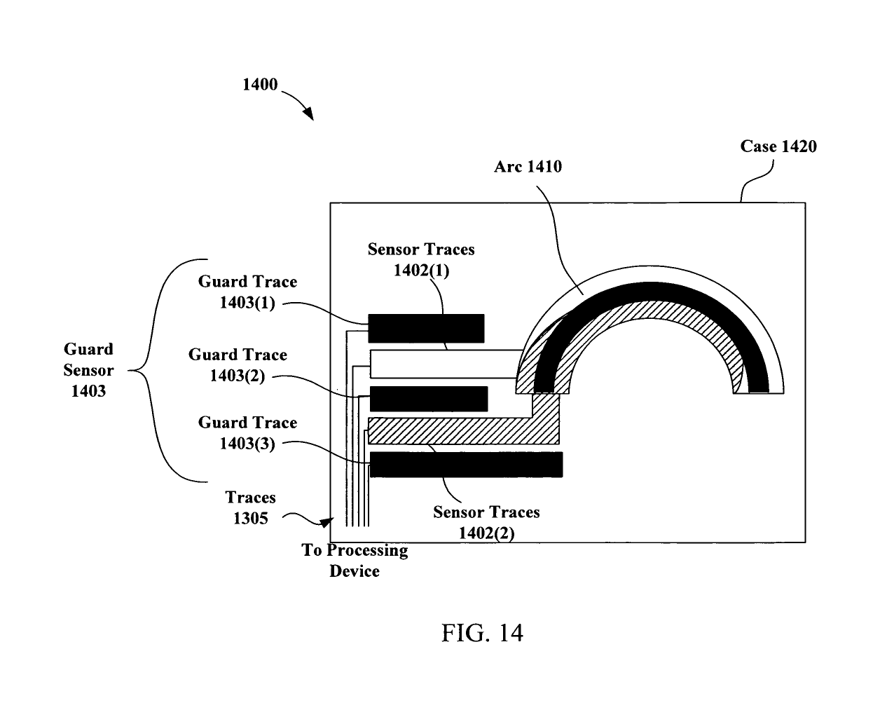

In the embodiment of FIG. 13, the processing device 210 includes seven pins, one pin for the guard sensor 1303 and six pins for the sensor elements 1301(1)-(6). Alternatively, the processing device 210 includes more or less pins than seven, such as illustrated, and described with respect to FIG. 14.

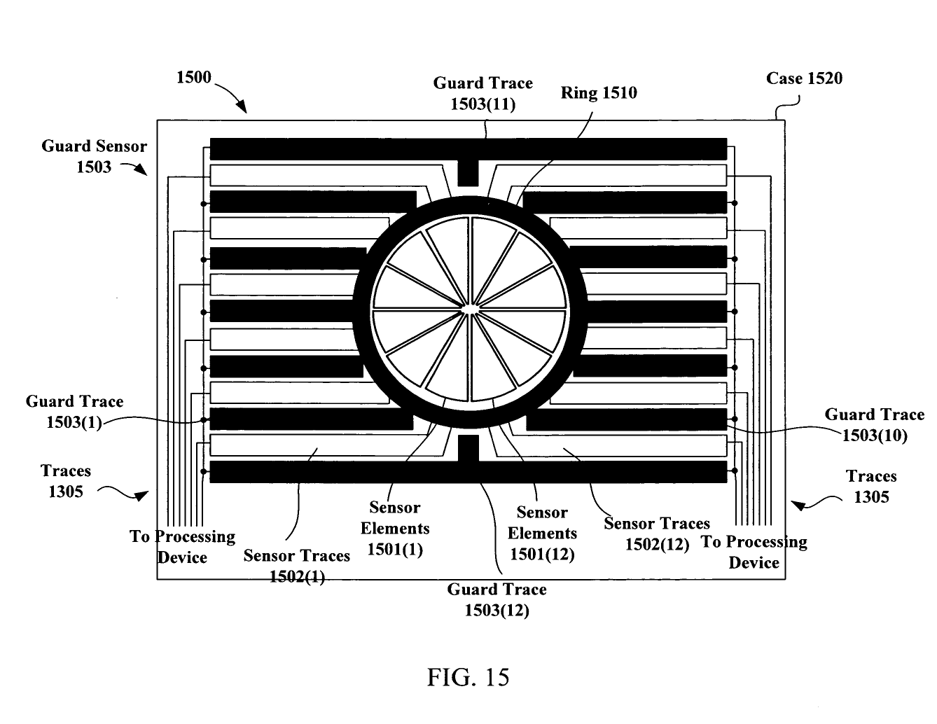

Also, in the embodiment of FIG. 13, the radial slider 1300 includes sensor elements 1301(1)-(6) that form an arc, instead of a closed circular slider. Alternatively, the radial slider 1300 may include additional sensor elements to form a closed, circular slider, such as illustrated in FIG. 15. Alternatively, other configurations of sliders may be used, such as a slider having non-linearly disposed sensor elements (e.g., closed circular slider, partially circular slider such as a radial slider, or the like) or a slider having linearly disposed sensor elements (e.g., linear slider). In this embodiment, the radial slider 1300 includes six sensor elements. Alternatively, the radial slider 1300 may include more or less sensor elements than six.

FIG. 14 illustrates a radial slider 1400 having two sensor traces 1401(1) and 1401(2) coupled to a processing device, and a guard sensor 1403 disposed outside an arc 1410 of the radial slider 1410 to prevent unintentional activations of the two sensor traces 1401(1) and 1401(2) by a conductive object outside of the arc 1410. Each sensor element 1401 is coupled to a sensor trace 1402. Each sensor trace 1402 is coupled to one of the traces 1305, which are coupled to the processing device 210. In one embodiment, the sensor traces 1401(1) and 1401(2) are routed to a side of a case 1420 that houses the radial slider and the processing device 210, such as a mobile handset, or other electronic device.

The guard sensor 1403 is disposed outside the arc 1410 to prevent the unintentional activations of the multiple sensor traces 1401(1) and 1401(2) by a conductive object outside of the arc 1410. In one embodiment, the guard sensor 1403 includes interleaved sensor traces, namely guard traces 1403(1)-(3). The guard traces 1403(1)-(3) are disposed between the sensor traces 1402(1) and 1402(2) outside the arc 1410 of sensor traces 1401(1) and 1401(2). In another embodiment, additional guard traces may be used, such as above the sensor elements, below the sensor elements, and/or within the arc 1410 of sensor traces 1401(1) and 1401(2) (not illustrated in FIG. 14).

In one embodiment, the guard traces 1403(1)-(3) are each individually coupled to a pin of the processing device, as illustrated in FIG. 14. In another embodiment, the guard traces 1403(1)-(3) are coupled together and are coupled to one of the traces 1305, which is coupled to a pin of the processing device. Alternatively, other combinations of coupling may be used to couple the guard sensor to one or more pins of the processing device.

In one embodiment, the guard sensor 1403 (e.g., guard traces 1403(1)-(3)) are disposed to prevent slider operations if a conductive object is detected outside the arc 1410. In another embodiment, the guard sensor 1403 (e.g., guard traces 1403(1)-(3)) are disposed to prevent slider operations if a conductive object is detected inside the arc 1410. Alternatively, the guard sensor 1403 (e.g., guard traces 1403(1)-(3)) are disposed to prevent slider operations if a conductive object is detected inside and outside the arc 1410.

In another embodiment, the guard sensor 1403 includes an additional guard trace to prevent unintentional activation of the sensor traces 1401(1) and 1401(2) by a conductive object that is larger than a finger. Alternatively, the additional guard trace is configured to reject activations of the sensor traces 1401(1) and 1401(2) when a conductive object is detected within the arc 1410.

In one embodiment, the sensor traces 1401(1) and 1401(2) and the guard traces 1403(1)-(3) are disposed on the same layer of sensing device assembly (e.g., same layer of a printed circuit board). Alternatively, the sensor traces 1401(1) and 1401(2) and the guard traces 1403(1)-(3) are disposed on separate layers of the sensing device. In one embodiment, the main sensor area of the sensing device is a single-sided conductive material, such as copper, silver, ITO, PEDOT, or the like. Alternatively, the sensing device is implemented in multiple layers.

In one embodiment, when a conductive object is detected in the sensor area of the sensor traces 1401(1) and 1401(2), represented by the arc 1410, a navigation function is performed by the processing device. When the conductive object is detected outside the sensor area represented by the arc 1410, the guard sensor 1403 prevents the unintentional activations of the sensor traces 1401(1) and 1401(2).

In the embodiment of FIG. 14, the processing device 210 includes five pins, three pins for the guard traces 1303(1)-(3), and two pins for the sensor traces 1401(1) and 1401(2). In another embodiment, the processing device 210 includes 3 pins, one pin for the guard sensor 1303 (e.g., guard traces 1303(1)-(3) are coupled together), and two pins for the sensor traces 1401(1) and 1401(2). Alternatively, the processing device 210 includes more or less pins than five.

Also, in the embodiment of FIG. 14, the radial slider 1400 includes sensor traces 1401(1) and 1401(2) that form an arc, instead of a closed circular slider. In another embodiment, the sensor traces 1401(1) and 1401(2) may be configured as a closed, circular slider, a linear slider, or the like. Alternatively, the radial slider 1400 may include additional sensor elements to form a closed, circular slider, such as two additional sensor traces like sensor traces 1401(1) and 1401(2).

It should be noted that the embodiments of FIG. 14 may be used to reduce the length of the sensor and guard traces 1402 and 1403. The embodiments of FIG. 14 may also be used to reduce the number of pins used on the processing device. Also, as described above, using tapered sensor elements, the slider can be implemented on one side of a printed circuit board without the use of vias.

FIG. 15 illustrates a circular slider 1500 having multiple sensor elements 1501(1)-(12) coupled to a processing device via sensor traces 1502(1)-(12), and a guard sensor 1503 disposed outside a ring 1510 of the circular slider 1500 to prevent unintentional activations of the multiple sensor elements 1501(1)-(12) by a conductive object outside of the ring 1510. Each sensor element 1501 is coupled to a sensor trace 1502. Each sensor trace 1502 is coupled to one of the traces 1305, which are coupled to the processing device 210. In one embodiment, the sensor elements 1501(1)-(12) are routed to a side of a case 1520 that houses the circular slider 1500 and the processing device 210, such as a mobile handset, or other electronic device.

The guard sensor 1503 is disposed outside the ring 1510 to prevent the unintentional activations of the multiple sensor elements 1501(1)-(12) by a conductive object outside of the ring 1510. In one embodiment, the guard sensor 1503 includes interleaved sensor traces, namely guard traces 1503(1)-(10). The guard traces 1503(1)-(10) are disposed between the sensor traces 1502(1)-(12) outside the ring 1510 of sensor elements 1501(1)-(12). In another embodiment, additional guard traces may be used, such as above the sensor elements, illustrated as the guard trace 1503(11), below the sensor elements 1501(1)-(12), illustrated as the guard trace 1503(12).

In one embodiment, the guard traces 1503(1)-(12) are coupled together and are coupled to one of the traces 1305, which is coupled to a pin of the processing device. In another embodiment, the guard traces 1503(1)-(12) are each individually coupled to a pin of the processing device. Alternatively, other combinations of coupling may be used to couple the guard sensor to one or more pins of the processing device.

In one embodiment, the guard sensor 1503 (e.g., guard traces 1503(1)-(12)) are disposed to prevent slider operations if a conductive object is detected outside the ring 1510. In another embodiment, the guard sensor 1503 includes an additional guard trace or guard sensor to prevent unintentional activation of the sensor elements 1501(1)-(12) by a conductive object that is larger than a finger.

In one embodiment, the sensor elements 1501(1)-(12) and the guard traces 1503(1)-(12) are disposed on the same layer of sensing device assembly (e.g., same layer of a printed circuit board). Alternatively, the sensor elements 1501(1)-(12) and the guard traces 1503(1)-(12) are disposed on separate layers of the sensing device. In one embodiment, the main sensor area of the sensing device is a single-sided conductive material, such as copper, silver, ITO, PEDOT, or the like. Alternatively, the sensing device is implemented in multiple layers.

In one embodiment, when a conductive object is detected in the sensor area of the sensor elements 1501(1)-(12), represented by the ring 1510, a navigation function is performed by the processing device. When the conductive object is detected outside the sensor area represented by the ring 1510, the guard sensor 1503 prevents the unintentional activations of the sensor elements 1501(1)-(12) and the corresponding sensor traces 1502(1)-(12).

In the embodiment of FIG. 15, the processing device 210 includes thirteen pins, one pin for the guard sensor 1303 and twelve pins for the sensor elements 1501(1)-(12). Alternatively, the processing device 210 includes more or less pins than thirteen, such as two pins for the guard sensor 1303 and twelve pins for the sensor elements 1501(1)-(12).

Also, in the embodiment of FIG. 15, the circular slider 1500 includes twelve sensor elements 1501(1)-(12) that form a circle, instead of a radial slider as illustrated in FIGS. 13 and 14. Alternatively, the circular slider 1500 may include five sensor elements or more.

Although not illustrated in FIG. 15, the circular slider 1500 may include an additional functional button disposed in a center of the circular slider 1500. The functional button may be a mechanical button, or alternatively, a touch-sensor button. Although the circular slider 1500 is a closed, circular slider, other configurations of sliders may be used, such as a slider having non-linearly disposed sensor elements (e.g., partially circular slider such as a radial slider, or the like) or a slider having linearly disposed sensor elements (e.g., linear slider). These other configurations of linear and non-linear sliders are known by those of ordinary skill in the art, and accordingly, additional descriptions of these configurations have not been described herein.

The embodiments described herein may also be used in a low power application to achieve low idle current. This may be done by minimizing the active time of the device. For example, when the device is in a sleep mode, if the device detects a waking event, such as the presence of a conductive object, the device only scans the guard sensor 603. If the capacitance measured on the guard sensor 603 is above the rejection threshold, the device may transition back to sleep mode, instead of going to full active mode with all sensor elements being scanned. However, if the capacitance is not above the rejection threshold, the device scans the sensor elements 804 and 805 of touch-sensor buttons 601 and 602. If the device detects that both the touch-sensor buttons 601 and 602 have been pressed, the device wakes up to full active mode, otherwise, the device remains in the sleep mode. In effect, this reduces the current of the device to have a low idle current. In one embodiment, the current of the device during the active mode is approximately 2.0 mA, during the sleep mode is approximately 25 uA, resulting in the idle current being approximately 38 uA. Alternatively, other current levels may be used for the active mode, sleep mode, which results in different idle currents.

As described above, the embodiments described herein may allow designers to maintain a completely flat capacitive touch panel, free of guard rails or recesses. The embodiments described herein may also allow multiple touch-sensor buttons to be activated simultaneously. The embodiments described herein may also allow the customization of a guard sensor in shape, size, and/or location to reject foreign objects that unintentionally activate the touch-sensor buttons. Other embodiments allow the customization of the guard sensor and the tuning of the gain or sensitivity of the circuit using the settings of the processing device to prevent the unintentional activations of the touch-sensor buttons.

Embodiments of the present invention, described herein, include various operations. These operations may be performed by hardware components, software, firmware, or a combination thereof. As used herein, the term “coupled to” may mean coupled directly or indirectly through one or more intervening components. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Certain embodiments may be implemented as a computer program product that may include instructions stored on a machine-readable medium. These instructions may be used to program a general-purpose or special-purpose processor to perform the described operations. A machine-readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; electrical, optical, acoustical, or other form of propagated signal (e.g., carrier waves, infrared signals, digital signals, etc.); or another type of medium suitable for storing electronic instructions.

Additionally, some embodiments may be practiced in distributed computing environments where the machine-readable medium is stored on and/or executed by more than one computer system. In addition, the information transferred between computer systems may either be pulled or pushed across the communication medium connecting the computer systems.

Although the operations of the method(s) herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

What is claimed is:

1. A method, comprising:
detecting a presence of a conductive object on a sensing device having one or more sensor elements; and
preventing unintentional activation of the one or more sensor elements caused by the conductive object using an additional sensor element.

2. The method of claim 1, wherein preventing the unintentional activation comprises:
coupling each of the one or more sensor elements to the additional sensor element;
measuring a capacitance on the one or more sensor elements and the additional sensor element; and
determining whether the capacitance is greater than a rejection threshold.

3. The method of claim 2, wherein preventing the unintentional activation further comprises preventing the unintentional activation of the one or more sensor elements when the capacitance is greater than the rejection threshold.

4. The method of claim 1, wherein preventing the unintentional activation comprises:
measuring a capacitance on the additional sensor element; and
determining whether the capacitance is greater than a rejection threshold.

5. The method of claim 4, wherein preventing the unintentional activation further comprises preventing the unintentional activation of the one or more sensor elements when the capacitance is greater than the rejection threshold.

6. The method of claim 1, wherein the sensing device is a touch panel having a first touch-sensor button and a second touch-sensor button, each touch-sensor button comprising a sensor element, and wherein preventing the unintentional activation comprises:
determining whether a first sensor element of the first touch-sensor button is activated;
determining whether a second sensor element of the second touch-sensor button is activated; and
determining whether the additional sensor element is activated.

7. The method of claim 6, wherein preventing the unintentional activation further comprises:
determining that the one or more sensor elements have been activated when the first and second sensor elements are not activated, regardless of whether the additional sensor element is activated;
determining that the first touch-sensor button has been activated when the first sensor element is activated and the additional sensor element is not activated;
determining that the second touch-sensor button has been activated when the second sensor element is activated and the additional sensor element is not activated;
determining that the first touch-sensor button and the second touch-sensor button have been activated when the first and second sensor elements are activated and the additional sensor element is not activated; and
determining that neither the first or second sensor elements have been activated when the additional sensor element is activated, regardless of whether the first sensor element has been activated and regardless of whether the second sensor element has been activated.

8. An apparatus, comprising:
a first sensor element of a sensing device;
one or more additional sensor elements of the sensing device; and
a processing device coupled to the sensing device, wherein the processing device is configured to prevent unintentional activations of the one or more sensor elements by a conductive object using the first sensor element.

9. The apparatus of claim 8, wherein the processing device is configured to detect a presence of the conductive object on the sensing device.

10. The apparatus of claim 9, wherein the processing device is configured to measure the capacitance on the first sensor element to detect the presence of the conductive object on the sensing device.

11. The apparatus of claim 9, wherein the processing device is configured to couple the first sensor element and the one or more additional sensor elements and to measure the capacitance on the first sensor element and the one or more additional sensor elements to detect the presence of the conductive object.

12. The apparatus of claim 8, wherein the unintentional activations is caused by the conductive object, wherein the conductive object is larger than a finger.

13. The apparatus of claim 12, wherein the conductive object is a disc (DVD or CD).

14. The apparatus of claim 12, wherein the conductive object is a hand.

15. The apparatus of claim 12, wherein the conductive object has a surface area that is approximately four to six times a surface area of one of the one or more additional sensor elements.

16. The apparatus of claim 8, wherein the first sensor element is disposed between the one or more additional sensor elements.

17. The apparatus of claim 8, wherein the first sensor element is disposed to substantially surround the one or more additional sensor elements.

18. The apparatus of claim 12, wherein the first sensor element and the one or more additional sensor elements reside in a control panel.

19. The apparatus of claim 12, wherein the first sensor element and the one or more additional sensor elements reside in a mobile handset.

20. The apparatus of claim 8, wherein the sensing device is a touch panel having a first touch-sensor button and a second touch-sensor button, each touch-sensor button comprising a sensor element of the one or more additional sensor elements, wherein the processing device is configured to determine whether the first touch-sensor button has been activated, whether the second touch-sensor button has been activated, and whether the first sensor element has been activated, and wherein the processing device is configured to reject the activations of either the first or second touch-sensor buttons when the first sensor element has been activated.

21. The apparatus of claim 8, wherein the sensing device is a radial slider having the one or more additional sensor elements disposed in an arc and the first sensor element disposed outside the arc, wherein the processing device is configured to determine whether the one or more additional sensor elements have been activated, and whether the first sensor element has been activated, and wherein the processing device is configured to reject the activations of the one or more sensor element when the first sensor element has been activated.

22. The apparatus of claim 8, wherein the sensing device is a circular slider having the one or more additional sensor elements disposed within a ring of the circular slider and the first sensor element disposed outside the ring, wherein the processing device is configured to determine whether the one or more additional sensor elements have been activated, and whether the first sensor element has been activated, and wherein the processing device is configured to reject the activations of the one or more sensor element when the first sensor element has been activated.

23. An apparatus, comprising:
means for detecting a presence of a conductive object on a sensing device having one or more sensor elements; and
means for preventing unintentional activation of the sensing device.

24. The apparatus of claim 23, wherein the means for preventing unintentional activation of the sensing device comprises means for measuring a capacitance on an additional sensor element of the sensing device.

25. The apparatus of claim 24, wherein the means for preventing unintentional activation of the sensing device comprises:
means for coupling each of the one or more sensor elements of the sensing device to the additional sensor element; and
measuring a capacitance on the one or more sensor elements and the additional sensor element.

26. An apparatus, comprising:
a touch-sensor button, wherein the touch-sensor button comprises a sensor element; and
a button housing, wherein the sensor elements is recessed from a surface of the button housing, and wherein the recessed sensor element is disposed to prevent unintentional activation of the touch-sensor button by a conductive object.

27. The apparatus of claim 26, further comprising a processing device to detect the presence of the conductive object on the touch-sensor button.

28. The apparatus of claim 26, wherein the processing device is configured to measure a capacitance on the sensor element of the touch-sensor button.
